(19) United States
(12) Patent Application Publication
(10) Pub. No.: US 2019/0266844 A1
(43) Pub. Date: Aug. 29, 2019

(54) HEDGED OFFER SKILL WAGERING SYSTEM

(71) Applicant: Gamblit Gaming, LLC, Glendale, CA (US)

(72) Inventors: Zachary Foley, Los Angeles, CA (US); Timothy Isaacson, Monrovia, CA (US); Dana Sharon, Vancouver (CA); David Stucke, Las Vegas, NV (US); Edvard Toth, Santa Monica, CA (US)

(21) Appl. No.: 16/169,992

(22) Filed: Oct. 24, 2018

Related U.S. Application Data
(63) Continuation-in-part of application No. 15/978,087, filed on May 11, 2018.
(60) Provisional application No. 62/505,061, filed on May 11, 2017.

(51) Int. Cl. G07F 17/32

(52) U.S. Cl. CPC G07F 17/3262; G07F 17/3244; G07F 17/3295; G07F 17/3276; G07F 17/3216

(57) ABSTRACT

Hedged offer skill wagering systems are disclosed. During operation, a multiplayer hedged offer skill wagering system presents an interactive application in the form of an interactive game to two or more players, receives a selection from each of the two or more player's of respective hidden possible award values from a set of hidden possible award values, determines a winning player based on the relative performance of the two or more players in the interactive game, presents to the winning player a hedged offer award value, receives a selection from the winning player a selection of the hedged offer award value or a selection of a the player's respective hidden possible award value, and awards to winning player the selected award value. a single player hedged offer skill wagering system presents an interactive game to a single player and offers hedged offer award values to the player during interactive gameplay.

### CROSS REFERENCE TO RELATED APPLICATIONS

This application is a continuation in part of U.S. application Ser. No. 15/978,087, filed May 11, 2018, which claims the benefit of U.S. Provisional Patent Application No. 62/505,061, filed May 11, 2017, the contents of each of which are incorporated by reference herein.

### FIELD OF THE INVENTION

Embodiments of the invention are generally related to communications within data processing systems. More particularly, embodiments of the invention relate to the communication and processing of skill wagering data.

### BACKGROUND

The gaming industry has traditionally developed electronic gaming machines (EGMs) that implement simple chance-based wagers. However, more complicated skill-based wagering processes need communication and processing systems that are better suited for implementing such processes. Various aspects of embodiments of the invention meet such a need.

### SUMMARY OF THE INVENTION

Systems and methods in accordance with embodiments of the invention provide a communication and data processing system constructed for a hedged offer skill wagering system.

In an embodiment, a multiplayer hedged offer skill wagering system, includes at least one processor, and a memory connected to the at least one processor, wherein the memory stores processor executable instructions that when executed by the processor cause the processor to present an interactive application in the form of an interactive game to two or more players, receive a selection from each of the two or more player's of respective hidden possible award values from a set of hidden possible award values, determine a winning player based on the relative performance of the two or more players in the interactive game, present to the winning player a hedged offer award value, receive a selection from the winning player a selection of the hedged offer award value or a selection of a the player's respective hidden possible award value, and award to winning player the selected award value.

In another embodiments, the hedged offer skill wagering system includes an enclosure constructed to mount a user input device operatively connected to the processor, a user output device operatively connected to the processor, a credit input device operatively connected to the processor, and a credit output device operatively connected to the processor.

In another embodiment, a single player hedged offer skill wagering system includes at least one processor, and a memory connected to the at least one processor, wherein the memory stores processor executable instructions that when executed by the processor cause the processor to, present an interactive application in the form of an interactive game a player, during play of the interactive game by the player, present to the player a hedged offer award value, receive a selection from the winning player a selection of the hedged offer award value or a selection by the player to continue playing the interactive game; and award to winning player the selected hedged offer award value when the player selects to receive the hedged offer award value.

In another embodiment, a single player hedged offer skill wagering system further includes an enclosure constructed to mount a user input device operatively connected to the processor, a user output device operatively connected to the processor, a credit input device operatively connected to the processor; and a credit output device operatively connected to the processor.

In an embodiment of the invention, a process controller operates as an interface between an interactive controller that resolves a skill wager outcome of a skill wager proposition and a wagering subcontroller that determines random components. By virtue of this feature, the wagering subcontroller is isolated from the interactive controller allowing the interactive controller to operate in an unregulated environment while allowing the wagering subcontroller to operate in a regulated environment, thus providing for more efficient management of the operations of such a system.

In another embodiment of the invention, a single wagering subcontroller may provide services to two or more interactive controllers, thus allowing a hedged offer skill wagering system to operate more efficiently over a large range of scaling.

In another embodiment of the invention, multiple types of interactive controllers using different operating systems may be interfaced to a single type of process controller without requiring customization of the process controller and/or the wagering subcontroller, thus improving the efficiency of the process controller and/or the wagering subcontroller by reducing complexity associated with maintaining separate process controllers and/or wagering subcontrollers for each type of interactive controller.

In another embodiment of the invention, an interactive controller may be provided as a player device under control of a player while maintaining the process controller in an environment under the control of a regulated operator of wagering equipment, thus providing for a more economical system as the regulated operator need not expend capital to purchase interactive controllers.

In another embodiment of the invention, data communicated between the controllers may be encrypted to increase security of the hedged offer skill wagering system.

In another embodiment of the invention, a process controller isolates random component logic and skill wager proposition logic as unregulated logic from a regulated wagering subcontroller, thus allowing errors in the skill wager proposition logic and/or random component logic to be corrected, new skill wager proposition logic and/or random component logic to be used, or modifications to be made to the skill wager proposition logic and/or random component logic without a need for time-consuming regulatory approval.

In another embodiment of the invention, an interactive application may require extensive processing resources from an interactive controller leaving few processing resources for the functions performed by a process controller and/or a wagering subcontroller. By virtue of an architecture of some embodiments of the invention, processing loads may be distributed across multiple devices such that operations of the interactive controller may be dedicated to an interactive application and the processes of the process controller and/or wagering subcontroller are not burdened by the requirements of the interactive application.

In another embodiment of the invention, a hedged offer skill wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many such embodiments, one or more components of a hedged offer skill wagering system are distributed in close proximity to each other and communicate using a local area network and/or a communication bus. In several embodiments, an interactive controller and a process controller of a hedged offer skill wagering system are in a common location. In some embodiments, a process controller communicates with an external interactive controller. In various embodiments, these multiple controllers and subcontrollers can be constructed from or configured using a single device or a plurality of devices such that a hedged offer skill wagering system is executed as a system in a virtualized space such as, but not limited to, where a wagering subcontroller and a process controller are large scale centralized servers and are operatively connected to distributed interactive controllers via a wide area network such as the Internet or a local area network. In such embodiments, the components of a hedged offer skill wagering system may communicate using a networking protocol or other type of device-to-device communications protocol.

In another embodiment of the invention, an interactive controller is an interactive server acting as a host for managing head-to-head player interactions over a network of interactive subcontrollers connected to the interactive server using a communication link. The interactive server provides an environment where players can compete directly with one another and interact with other players.

### BRIEF DESCRIPTION OF THE DRAWINGS

FIG. 1 is a diagram of a structure of a hedged offer skill wagering system in accordance with various embodiments of the invention.

FIG. 2A is a diagram of an electronic gaming machine configuration of a hedged offer skill wagering system in accordance with various embodiments of the invention.

FIG. 2B is a diagram of a table electronic gaming machine configuration of a hedged offer skill wagering system in accordance with various embodiments of the invention.

FIG. 2C is a diagram of a virtual reality gaming machine configuration of a hedged offer skill wagering system in accordance with various embodiments of the invention.

FIG. 3 is a diagram of distributed hedged offer skill wagering systems in accordance with various embodiments of the invention.

FIGS. 4A and 4B are diagrams of a structure of an interactive controller of a hedged offer skill wagering system in accordance with various embodiments of the invention.

FIG. 5 is a diagram of a structure of a process controller of a hedged offer skill wagering system in accordance with various embodiments of the invention.

FIG. 6 is a diagram of a structure of a credit processing controller of a hedged offer skill wagering system in accordance with various embodiments of the invention.

FIG. 7 is a block diagram of a process of a hedged offer skill wagering system in accordance with various embodiments of the invention.

FIG. 8 is a sequence diagram of interactions between components of a hedged offer skill wagering system in accordance with various embodiments of the invention.

FIGS. 9A to 9I illustrate portions of a user interface of a multiplayer hedged offer skill wagering system in accordance with various embodiments of the invention.

FIGS. 10A and 10B are activity diagrams of a multiplayer hedged offer skill wagering system in accordance with various embodiments of the invention.

FIGS. 11A to 11G illustrate portions of a user interface of a single player hedged offer skill wagering system in accordance with various embodiments of the invention.

FIG. 12 is an activity diagram of a single player hedged offer skill wagering system in accordance with various embodiments of the invention.

### DETAILED DESCRIPTION

An example conventional slot machine game is a mechanical 3 reel slot machine having 22 possible positions or symbols on each reel. In such a slot machine game, there are 22\hat{ }3, or 10,648, possible pays based on the combinations of the reel positions. Each time the slot machine is played, a single pay is determined from a single independent random event, namely the spinning of the mechanical reels. If such a 3 reel slot machine is implemented on a conventional electronic gaming machine having virtual video reels, each possible pay is explicitly enumerated in a paytable that is used to determine a pay as well as determine an animation sequence of the video virtual reels that corresponds to the pay. The combination of a pay and an associated reel animation sequence constitute a game feature. Such a paytable will have at least 10,648 locations, one position for each possible combination of the 3 reels, with each location representing a pay and a representation of the stopped position of the 3 reels. If digital storage of each pay requires 8 bytes of storage, such a paytable can be stored in approximately 83 kilobytes of digital memory (8 bytes of data for each game feature×10,648 possible pays/1024 Bytes per kilobyte). In operation, a single random number is determined, and that random number is used as an index into the paytable to select a game feature of a single pay and reel animation identifier from the 10,648 possible pays and reel animations. Accordingly, approximately 83 kilobytes of memory is needed to store the enumerated game features of a simple slot machine game having approximately 10 thousand game features on a conventional electronic gaming machine.

In accordance with various embodiments, a complex wagering game can be modeled using a multidimensional game space or manifold where each dimension of the manifold is associated with a stochastic event of the complex wagering game. Such a complex wagering game will have multiple states within the game space with some of the states being intermediate states and some of the states being wager outcome states. Complex wagering games implemented using interactive wagering processes as described herein have sets of intermediate states and wager outcome states whose sizes are many orders of magnitude larger than a set of pays of a simple slot machine game. In an example embodiment, a complex wagering game includes a display where selectable chance-based outcomes are displayed to a player as a set of possible wager outcome states. The display includes 9 locations with each location having twenty-two possible chance-based outcomes. Such a complex wagering game display has 1,207,269,217,792, or over 1.2 trillion, possible wager outcome states. If 8 bytes of digital memory are used to store each wager outcome state, then a complete enumeration of all of wager outcome states, as required using conventional electronic game machine architecture, would require 9.6 terabytes of memory storage. However, utilization of a interactive wagering system and interactive wagering processes as described herein reduces storage memory requirements for such a complex wagering game feature to less than 1 megabyte. Such a reduction in memory requirements reduces the amount of physical and/or virtual memory needed to implement the complex wagering game, and also may reduce an amount of time needed to generate such a complex wagering game display.

In another example embodiment, a complex wagering game has a game space with 17 dimensions and approximately 1,576,418,005,371,090,000,000, or over 1.5 sextillion possible intermediate states and wager outcome states. Enumeration and storage of such a set of states for implementation of the complex wagering game on a conventional electronic gaming machine would require over 12.6 zettabytes of addressable memory storage which is simply not possible using conventional processor architecture; accordingly, such complex wagering games are simply not implementable using conventional electronic gaming machines. However, such complex wagering games may be implemented on various embodiments of an interactive wagering system as described herein.

A hedged offer skill wagering system allows for the management of independent skill wager elements within a skill-based wagering game where the independent skill wager elements have one or more random components. One or more independent skill wager elements compose a skill wager proposition. In some embodiments of a hedged offer skill wagering system, an interactive application executed by an interactive controller provides skill wager proposition of the hedged offer skill wagering system. The interactive controller is operatively connected to a process controller that manages and configures the interactive controller and the interactive application, and determines skill wager propositions having random components determined by a wagering subcontroller that are resolved as skill wager outcomes determined by the interactive application.

In some embodiments, the interactive controller also provides a wagering user interface that is used to receive commands and display data for a wagering process and wagering outcome determined from the skill wager outcome in accordance with a skill wager proposition. The content of the wagering user interface is controlled by the process controller and includes content provided by the wagering subcontroller and the interactive controller.

In various embodiments, an interactive controller provides a management user interface used to manage a player profile.

Many different types of interactive applications may be utilized with the hedged offer skill wagering system. In some embodiments, the interactive application reacts to the physical activity of a player. In these embodiments, the interactive application senses player interactions with the interactive application through one or more sensors that monitor the player's physical activities. Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors.

In some embodiments, the interactive application implements a skill-based game and interacts with the player by sensing skillful interactions with an interactive user interface generated by the interactive application.

In many embodiments, the interactive application generates various types of interactive elements in an interactive application environment. In some embodiments, these interactive elements are interactive application resources utilized within the interactive application environment to provide an interactive experience for a player.

In accordance with some embodiments, a random component of the skill wager proposition can influence interactive elements in the interactive application environment such as, but not limited to, automatically providing one or more new interactive elements, automatically restoring one or more consumed interactive elements, automatically causing the loss of one or more interactive elements, and automatic restoration or placement of one or more fixed interactive elements.

In various embodiments, the wagers may be made using one or more credits.

In some embodiments, credits can be one or more credits that are purchased using, and redeemed in, a real world currency having a real world value.

In many embodiments, credits can be one or more credits in a virtual currency. Virtual currency is an alternate currency that can be acquired, purchased or transferred by or to a player, but does not necessarily directly correlate to a real world currency. In many such embodiments, credits in a virtual currency are allowed to be purchased using a real world currency but are prevented from being redeemed in a real world currency having a real world value.

In several embodiments, interaction with the interactive elements of the interactive application, application credits can be optionally consumed and/or accrued within the interactive application as a result of interaction with the interactive elements. Application credits can be in the form of, but not limited to, application environment credits, experience points, and points generally.

In various embodiments, application credits are awarded on the basis of skillful interactions with the interactive elements of a skill-based interactive application. The skill-based interactive application can have one or more scoring criteria, embedded within a process controller and/or an interactive controller that provides the skill-based interactive application, that can be used to determine player performance against one or more goals of the skill-based interactive application in accordance with a skill wager proposition.

In many embodiments, application credits can be used to purchase in-application items, including but not limited to, application interactive elements that have particular properties, power ups for existing items, and other item enhancements.

In some embodiments, application credits may be used to earn entrance into a sweepstakes drawing, to earn entrance in a tournament with prizes, to score in the tournament, and/or to participate and/or score in any other game event.

In several embodiments, application credits can be stored on a player-tracking card, voucher or in a network-based player tracking system where the application credits are attributed to a specific player.

In many embodiments, a skill wager proposition includes a wager of application credits for payout of application credits, interactive application elements, and/or interactive application objects in accordance with the chance-based proposition.

In a number of embodiments, a wager of an amount of credits results in a payout of application credits, interactive elements, and/or interactive application objects that have a credit value if cashed out.

In some embodiments, interactive application objects include in-application objects that may be utilized to enhance player interactions with the interactive application. Such objects include, but are not limited to, power-ups, enhanced in-application items, and the like. In some embodiments, the interactive application objects include objects that are detrimental to player interactions with the interactive application such as, but not limited to, obstructions in the interactive application space, a temporary handicap, an enhanced opponent, and the like.

In numerous embodiments, an interactive application command is an instruction by a process controller to an interactive controller and/or an interactive application of the interactive controller to modify a state of an interactive application or modify one or more interactive application resources or interactive elements. In some embodiments, the interactive application commands may be automatically generated by the process controller using one or more of a random component and/or application environment variables. An interactive application command can be used by a process controller control many processes of an interactive application, such as, but not limited to, an causing an addition of a period of time available for a current interactive application session for the interactive application, an addition of a period of time available for a future hedged offer skill wagering system interactive application session or any other modification to the interactive application interactive elements that can be utilized during an interactive application session.

In some embodiments, asynchronous communications provided for by a hedged offer skill wagering system may reduce an amount of idle waiting time by an interactive controller of the hedged offer skill wagering system, thus increasing an amount of processing resources that the interactive controller may provide to an interactive application or other processes of the interactive controller. In many embodiments, asynchronous communications provided for by a hedged offer skill wagering system reduces an amount of idle waiting time by a process controller, thus increasing an amount of processing resources that the process controller may provide to determine random components, and other processes provided by the process controller.

In some embodiments, a wagering subcontroller of a hedged offer skill wagering system may be operatively connected to a plurality of interactive controllers through a process controller and the asynchronous communications provided for by the process controllers allows the wagering subcontroller to operate more efficiently by providing random components to a larger number of interactive controllers than would be achievable without the process controller of the hedged offer skill wagering system.

In some embodiments, a hedged offer skill wagering system including a process controller operatively connected to a wagering subcontroller and operatively connected to an interactive controller wherein the process controller provides for simplified communication protocols for communications of the interactive controller as the interactive controller may communicate interactions with an interactive application provided by the interactive controller to the process controller without regard to a nature of a chance-based proposition.

In various embodiments, a hedged offer skill wagering system including a process controller operatively connected to a wagering subcontroller and operatively connected to an interactive controller may provide for simplified communication protocols for communications of the wagering subcontroller as the wagering subcontroller may receive skill wager proposition requests and communicate determined skill wager propositions having random components without regard to a nature of an interactive application provided by the interactive controller.

In some embodiments, a hedged offer skill wagering system including a process controller operatively connecting a wagering subcontroller to an interactive controller may provide for reduced processing requirement for the interactive controller by offloading the execution of a random number generator from the interactive controller to the process controller. In various such embodiments, additional processing resources may be made available to graphics processing or other processing intensive operations by the interactive controller because of the offloaded random number processing.

In various embodiments, a hedged offer skill wagering system including a process controller operatively connecting a wagering subcontroller to an interactive controller provides for operation of the interactive controller in an unsecure location or manner, while providing for operation of the wagering subcontroller in a secure location or manner.

In some embodiments, a hedged offer skill wagering system including a process controller operatively connecting a wagering subcontroller to an interactive controller allows the skill wagering system to have regulated components coupled to unregulated components in a heterogeneous regulated environment. For example, in several such embodiments, the interactive controller may be a device that is not regulated by a wagering regulatory agency whereas the wagering subcontroller is regulated by the wagering regulatory agency. A process controller of a hedged offer skill wagering system may provide for isolation of the processing of the interactive controller from the processing of the wagering subcontroller. In such a heterogeneous regulatory environment, the process controller may or may not be itself a regulated by the wagering regulatory authority. In addition, components of an interactive application executed by the interactive controller may be either regulated or unregulated by the wagering regulatory agency.

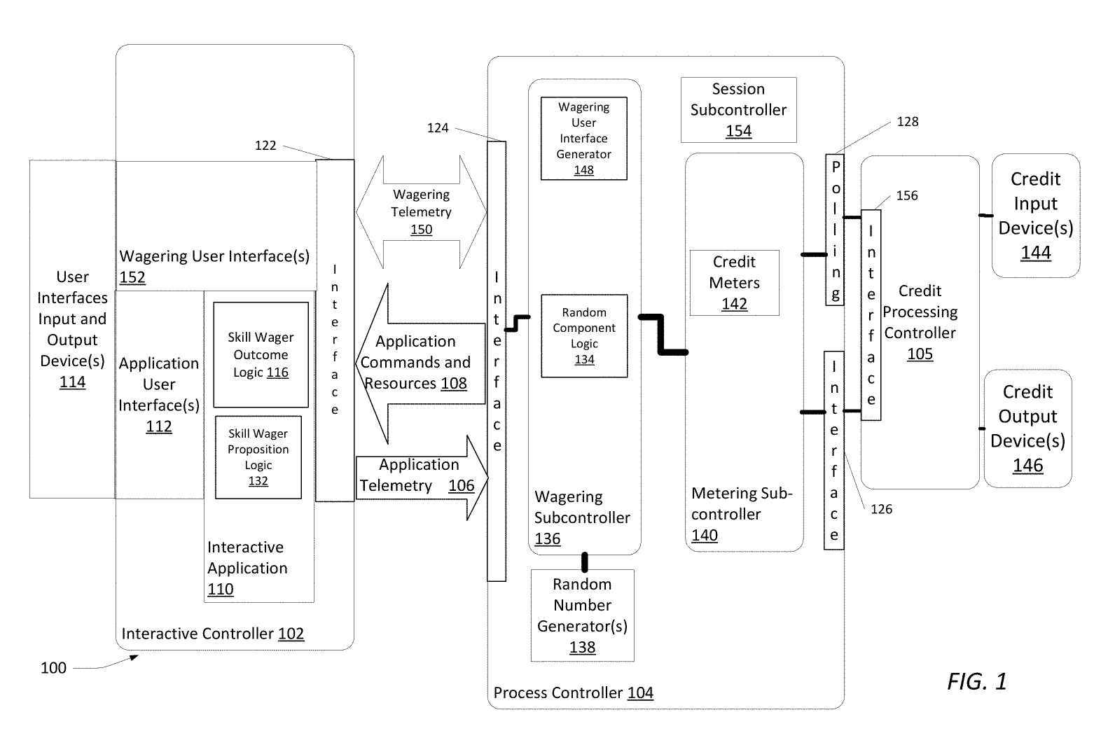

FIG. 1 is a diagram of a structure of a hedged offer skill wagering system in accordance with various embodiments of the invention. The hedged offer skill wagering system 100 includes an interactive controller 102, a process controller 104, and a credit processing controller 105. The interactive controller 102 is operatively connected to, and communicates with, the process controller 104. The process controller 104 is also operatively connected to, and communicates with, the credit processing controller 105.

In various embodiments, the interactive controller 102 executes an interactive application 110 and provides one or more user interface input and output devices 114 so that one or more players can interact with the interactive application 110. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The interactive controller 102 provides for player interactions with the interactive application 110 by executing the interactive application 110 that generates an application user interface 112 that utilizes the user interface input devices to detect player interactions with the interactive controller 102 and generates an interactive user interface that is presented to the player utilizing the user interface output devices.

In some embodiments, one or more components an interactive controller are housed in an enclosure such as a housing, cabinet, casing or the like. The enclosure further includes one or more player accessible openings or surfaces that constructed to mount the user interface input devices and/or the user interface output devices.

The interactive controller 102 is operatively connected to, and communicates with, the process controller 104. The interactive controller 102 receives application command and resource data 108 that may include, but is not limited to, random components, skill wager proposition data, application command data, and resource data from the process controller 104. Via the communication of the application command and resource data 108, the process controller 104 can control the operation of the interactive controller 102 by communicating control parameters to the interactive application 110 during the interactive application's execution by the interactive controller 102.

In many embodiments, the interactive application 110 of the interactive controller 102 utilizes skill wager proposition logic 132 to generate one or more independent skill wager elements using random components received from the process controller 104 as part of the application command and resource data 108.

In an example embodiment, a skill wager proposition is generated by executing proposition commands included in a script written in a scripting language.

In some embodiments, during execution of the interactive application 110 by the interactive controller 102, the interactive controller 102 communicates, as application telemetry data 106, player interactions with one or more interactive elements of the application user interfaces 112 of the interactive application to the process controller 104. The application telemetry data 106 may include, but is not limited to, application environment variables that indicate the state of the interactive application 110, interactive controller data indicating a state of the interactive controller 102, player actions and interactions between one or more players and the interactive application 110 provided by the interactive controller 102, and utilization of interactive elements including independent skill wager elements in the interactive application 110 by one or more players.

In some embodiments, the application telemetry data 106 includes a skill wager outcome as determined by the interactive application 110 using skill wager outcome logic 116, and player interactions with one or more application user interfaces 112 of the interactive application. In many embodiments, the application telemetry data includes a request by the interactive application for a random component for utilization during a player's interaction with an independent skill wager element.

In some embodiments, the interactive application 110 is a skill-based interactive application. In such embodiments, execution of the skill-based interactive application 110 by the interactive controller 102 is based on one or more players' skillful interaction with the interactive application 110, such as, but not limited to, the players' utilization of the interactive elements of the interactive application during the players' skillful interaction with the skill-based interactive application. In such an embodiment, the process controller 104 communicates with the interactive controller 102 in order to allow the coupling of the skill-based interactive application to random components determined by the wagering subcontroller 136 of the process controller 104.

In some embodiments, the interactive application 110 uses skill wager proposition data, interactive application command data, and/or resource data included in the application commands and resources 108 to generate a skill wager proposition presented to one or more players as one or more application user interfaces 112 using one or more output devices of user interface and output device(s) 114. The one or more players skillfully interact with the one or more application user interfaces 112 using one or more of input devices of the user interface input and output devices 114. The interactive application 110 determines a skill wager outcome based on the skillful interactions of the one or more players and communicates data of the determined skill wager outcome to the process controller 104 as part of the application telemetry 106. In some embodiments, the interactive application 110 also communicates as part of the application telemetry data 106, data encoding the one or more players' interactions with the interactive application 110.

In some embodiments, the skill wager outcome logic 116 and the skill wager proposition generated by the skill wager proposition logic 132 are for a skill wager proposition for one or more players. The interactive application 110 determines one or more skill wager outcomes based on the skill wager proposition and the one or more players' skillful interactions with the interactive application. The interactive controller communicates data of the one or more skill wager outcomes to the process controller 104 as part of the application telemetry data 106.

In some embodiments, when a player interacts with an independent skill wager element within the interactive application 110, the interactive application 110 generates a request for a random component communicated by the interactive application 110 to the process controller 104. In response, the wagering subcontroller 136 of the process controller 104 generates a random component using one or more random number generators 138. The process controller 104 communicates the one or more random components as part of the application command and resource data 108 to the interactive application 110 and the interactive controller 102. The independent skill wager element utilizes the one or more random components to determine in part one or more skill wager outcomes.

In some embodiments, the interactive controller 102 includes one or more sensors that sense various aspects of the physical environment of the interactive controller 102. Examples of sensors include, but are not limited to: global positioning sensors (GPSs) for sensing communications from a GPS system to determine a position or location of the interactive controller; temperature sensors; accelerometers; pressure sensors; and the like. Sensor telemetry data is communicated by the interactive controller to the process controller 104 as part of the application telemetry data 106. The process controller 104 receives the sensor telemetry data and uses the sensor telemetry data to make wagering decisions.

In many embodiments, the interactive controller 102 includes one or more wagering user interfaces 118 used to display wagering data, via one or more of the user interface input and output devices 114, to one or more players.

In various embodiments, an application control interface 122 resident in the interactive controller 102 provides an interface between the interactive controller 102 and the process controller 104.

In some embodiments, the application control interface 122 implements an interactive controller to process controller communication protocol employing an interprocess communication protocol so that the interactive controller and the process controller may be implemented on the same device. In operation, the application control interface 122 provides application programming interfaces that are used by the interactive application 110 of the interactive controller 102 to communicate outgoing data and receive incoming data by passing parameter data to another process or application.

In some embodiments, the application control interface 122 implements an interactive controller to process controller communication protocol employing an interdevice communication protocol so that the interactive controller and the process controller may be implemented on different devices. The interdevice protocol may utilize a wired communication bus or wireless connection as a physical layer.

In various embodiments, the application control interface 122 implements an interactive controller to process controller communication protocol employing a networking protocol so that the interactive controller and the process controller may be implemented on different devices connected by a network. The networking protocol may utilize a wired communication bus or wireless connection as a physical layer. In many such embodiments, the network includes a cellular telephone network or the like and the interactive controller is a mobile device such as a smartphone or other device capable of using the telephone network. During operation, the application control interface 122 communicates outgoing data to an external device by encoding the data into a signal and transmitting the signal to an external device. The application control interface receives incoming data from an external device by receiving a signal transmitted by the external device and decoding the signal to obtain the incoming data.

The process controller 104 provides an interface between a skill wager proposition resolved for one or more players when skillfully interacting with the interactive application 110 provided by the interactive controller 102, and a random component, provided in-part by a wagering subcontroller 136.

In various embodiments, the process controller 104 includes a wagering subcontroller 136 having a rule-based decision engine that receives application telemetry data 106 from the interactive controller 102. The rule-based decision engine has random component logic 134. The decision engine uses the application telemetry data 106, along with random component logic 134, and a random result generated by one or more random number generators (RNGs) 138 to generate one or more random components.

In an embodiment, the application telemetry data 106 used by the decision engine encodes data about the operation of the interactive application 110 executed by the interactive controller 102.

In some embodiments, the application telemetry data 106 encodes interactions of a player, such as a player's interaction with an interactive element of the interactive application 110.

In many embodiments, the application telemetry data 106 includes a state of the interactive application 110, such as values of variables that change as the interactive application 110 executes.

In several embodiments, a decision engine includes one or more rules as part of random component logic 134 used by the decision engine to determine how a random component should generated. Each rule includes one or more variable values constituting a pattern that is to be matched by the wagering subcontroller 136 using the decision engine to one or more variable values encoded in the application telemetry data 106. Each rule also includes one or more actions that are to be taken if the pattern is matched. Actions can include automatically generating the random component in accordance with the random component logic 134 and a random result generated by one or more random number generators 138. During operation, the decision engine receives application telemetry data 106 from the interactive controller 102 via interface 160. The decision engine performs a matching process of matching the variable values encoded in the application telemetry data 106 to one or more variable patterns of one or more rules. If a match between the variable values and a pattern of a rule is determined, then the wagering subcontroller 136 performs the action of the matched rule.

In some embodiments, the wagering subcontroller 136 uses the random component in conjunction with the application telemetry data 106 and skill wager proposition logic, to automatically generate application command and resource data 108 including skill wager proposition data of a skill wager proposition that the process controller 104 communicates to the interactive controller 102 via interfaces 124 and 122.

In some embodiments, a decision engine includes one or more rules as part of skill wager proposition logic used by the decision engine to automatically generate application command and resource data 108 that is then communicated to the interactive controller 102. Each rule includes one or more variable values constituting a pattern that is to be matched to one or more variable values encoded in the application telemetry data 106 and the random component. Each rule also includes one or more actions that are to be automatically taken by the wagering subcontroller 136 if the pattern is matched. Actions can include automatically generating skill wager proposition data, interactive application command data, and/or resource data 108 and using the skill wager proposition data, interactive application command data, and/or resource data 108 to control the interactive controller 102 to affect execution of the interactive application 110 as described herein. In operation, wagering subcontroller 104 uses the decision engine to match the variable values encoded in the in the random component data to one or more patterns of one or more rules of the skill wager proposition logic 132. If a match between the variable values and a pattern of a rule is found, then the process controller automatically performs the action of the matched rule. In some embodiments, the process controller 104 uses the application telemetry data 106 received from the interactive controller 102 in conjunction with the random component to generate the skill wager proposition data, interactive application command data, and/or resource data 108.

The interactive controller receives the interactive application command data and resource data 108 and automatically uses the interactive application command data, and/or resource data 108 to configure and command the processes of the interactive application 110.

In some embodiments, the interactive application 110 operates utilizing a scripting language. The interactive application 110 parses scripts written in the scripting language and executes commands encoded in the scripts and sets variable values as defined in the scripts. In operation of such embodiments, the process controller 104 automatically generates interactive application command data, and/or resource data 108 in the form of scripts written in the scripting language that are communicated to the interactive controller 102 during execution of the interactive application 110. The interactive controller 102 receives the scripts and passes them to the interactive application 110. The interactive application 110 receives the scripts, parses the scripts and automatically executes the commands and sets the variable values as encoded in the scripts.

In many embodiments, the interactive application 110 automatically performs processes as instructed by commands communicated from the process controller 104. The commands command the interactive application 110 to perform specified operations such as executing specified commands and/or setting the values of variables utilized by the interactive application 110. In operation of such embodiments, the process controller 104 automatically generates commands that are encoded into the interactive application command data, and/or resource data 108 that are communicated to the interactive controller 102. The interactive controller 102 passes the interactive application command data, and/or resource data 108 to the interactive application 110. The interactive application parses the interactive application command data, and/or resource data and automatically performs operations in accordance with the commands encoded in the interactive application command data, and/or resource data 108.

In various embodiments, the process controller 104 includes one or more interfaces, 124, 126 and 128 that operatively connect the process controller 104 to one or more interactive controllers, such as interactive controller 102, and to one or more credit processing controllers, such as credit processing controller 105.

In some embodiments, one or more of the process controller interfaces implement a process controller to device or server communication protocol employing an interprocess communication protocol so that the process controller and one or more of an interactive controller, a wagering subcontroller, and/or a session subcontroller may be implemented on the same device. In operation, the process controller interfaces provide application programming interfaces or the like that are used by the process controller to communicate outgoing data and receive incoming data by passing parameter data to another process or application running on the same device.

In some embodiments, one or more of the process controller interfaces implement a process controller communication protocol employing an interdevice communication protocol so that the process controller may be implemented on a device separate from the one or more interactive controllers, the one or more session subcontrollers and/or the one or more wagering subcontrollers. The interdevice protocol may utilize a wired communication bus or wireless connection as a physical layer. In various embodiments, one or more of the process controller interfaces implement a process controller communication protocol employing a networking protocol so that the process controller may be operatively connected to the one or more interactive controllers, the one or more session subcontrollers, and/or the one or more wagering subcontrollers by a network. The networking protocol may utilize a wired communication bus or wireless connection as a physical layer. In many such embodiments, the network includes a cellular telephone network or the like and the one or more interactive controllers include a mobile device such as a smartphone or other device capable of using the telephone network. During operation, the one or more process controller interfaces communicate outgoing data to an external device or server by encoding the data into a signal and transmitting the signal to the external device or server. The one or more process controller interfaces receive incoming data from an external device or server by receiving a signal transmitted by the external device or server and decoding the signal to obtain the incoming data.

In several embodiments, the wagering subcontroller 136 is a controller for providing one or more wagers in accordance with one or more skill wager propositions provided by the hedged offer skill wagering system 100. Types of value of a wager can be one or more of several different types. Types of value of a wager can include, but are not limited to, a wager of an amount of credits corresponding to a real currency or a virtual currency, a wager of an amount of application credits earned through interaction with an interactive application, a wager of an amount of interactive elements of an interactive application, and a wager of an amount of objects used in an interactive application. A skill wager outcome determined for a wager in accordance with a skill wager proposition can increase or decrease an amount of the type of value used in the wager, such as, but not limited to, increasing or decreasing an amount of credits for a wager of credits. In various embodiments, a skill wager outcome determined for a wager in accordance with a skill wager proposition can increase or decrease an amount of a type of value that is different than a type of value of the wager, such as, but not limited to, increasing an amount of an object of an interactive application for a wager of credits.

In many embodiments, the process controller 104 includes one or more random number generators (RNGs) 138 for generating random results. The wagering subcontroller uses the one or more random results along with the random component logic 130 to generate one or more random components of a skill wager proposition.

In several embodiments, the process controller 104 includes a metering subcontroller 140 operatively connected to the credit processing controller 105 via interfaces 126 and 128. The metering subcontroller 140 communicates with the credit processing controller 105 to receive incoming credit data from the credit processing controller 105. The metering subcontroller 140 uses the incoming credit data to transfer credits into the hedged offer skill wagering system and onto one or more credit meters 142. The metering subcontroller 140 communicates outgoing credit data to the credit processing controller 105 to transfer credits off of the one or more credit meters 142 and out of the hedged offer skill wagering system.

In several embodiments, during operation, the metering subcontroller 140 communicates with the credit processing controller 105 to receive incoming credit data from the credit processing controller 105 and adds credits onto the one or more credit meters 110 at least partially on the basis of the incoming credit data. The one or more random number generators 138 execute processes that generate random results. The wagering subcontroller 136 uses the random component logic 134 and the random results to generate a random component of a skill wager proposition. The random component is communicated by the process controller as part of the application command and resource data 108 to the interactive controller 102. The interactive application 110 uses the random component along with the skill wager proposition logic 132 to generate a skill wager proposition. The interactive controller uses the skill wager proposition along with the skill wager outcome logic 116 to generate a presentation for one or more players using the one or more user interfaces 112. One or more players interact with the one or more application user interfaces 112 through the one or more user interface input and output devices 114. The interactive application 110 determines a skill wager outcome based on the interactions of the one or more players and communicates data of the skill wager outcome as part of the application telemetry data 106 to the process controller 104. The wagering sub controller 136 receives the skill wager outcome data and instructs the metering subcontroller 140 to add credits to, or deduct credits from, the one or more credit meters 110 based in part on the skill wager outcome data. For example, in some embodiments, the metering subcontroller is instructed to add an amount of credits to a credit meter of the one or more credit meters 110 when the skill wager outcome indicates a win for a player associated with the credit meter. In various embodiments, the metering subcontroller is instructed to deduct an amount of credits from the credit meter when the skill wager outcome indicates a loss for the player. At an end of a wagering session, the metering subcontroller 140 transfers credits off of the one or more credit meters 110 and out of the hedged offer skill wagering system by communicating outgoing credit data to the credit processing controller 105.

In many embodiments, the one or more random number generators 138 generate random numbers by continuously generating pseudo random numbers using a pseudo random number generator. A most current pseudo random number is stored in a buffer thus constantly refreshing the buffer. In many embodiments, the buffer is refreshed at a rate exceeding 100 times per second. When the wagering subcontroller 136 requests a random result, the wagering subcontroller 136 receives the stored most current pseudo random number from the buffer. As timing between requests for a random result is not deterministic, the resulting output from the buffer is a true random result such as a random number.

In some embodiments, a range of the value of a random result is mapped to one or more symbols representing one or more elements of a traditional chance-based proposition to create one or more random components. In several such embodiments, a random result is mapped to a virtual card of a deck of virtual cards. In another such embodiment, the random result is mapped to a virtual face of a virtual die. In yet another such embodiment, the random result is mapped to symbol of a virtual reel strip on a virtual reel slot machine. In yet another such embodiment, the random result is mapped to a pocket of a virtual roulette wheel. In some embodiments, two or more random results are mapped to appropriate symbols to represent a completed chance-based proposition. In one such embodiment, two or more random results are mapped to faces of two or more virtual dice to simulate a random result generated by throwing two or more dice. In another such embodiment, multiple random results are mapped to virtual cards from a virtual deck of cards without replacement. In yet another such embodiment, two or more random results are mapped to two or more virtual reel strips to create stop positions for a virtual multi-reel slot machine.

In some embodiments, the random component logic 134 includes one or more paytables that may be used to determine a chance-based wager outcome based on one or more random results from one or more random number generators. A wagering subcontroller uses the one or more paytables to map the one or more random results to a chance-based wager outcome. The one or more paytables are used to implement one or more chance-based wager propositions in conjunction with one or more random results of the one or more random number generators.

In various embodiments, the random components are used by the interactive application 110 along with skill wager proposition logic 132 to generate one or more interactive elements of the interactive application.

In some embodiments, the random components are used by the interactive application along with skill-wager outcome logic 116 and user interactions with interactive elements of the interactive application to determine a skill wager outcome.

In various embodiments, the process controller 104 uses a rule-based decision engine to automatically determine an amount of application credits to award to a player based at least in part on the application telemetry data 106 including skill wager outcome data and player interaction data with the interactive application 110 of the hedged offer skill wagering system. In numerous embodiments, the interactive application 110 is a skill-based interactive application and the application credits are awarded for a player's skillful interaction with the interactive application 110.

In some embodiments, the wagering subcontroller 136 uses a wagering user interface generator 148 to automatically generate wagering telemetry data 150 on the basis of amounts of credits on the one or more credit meters 142. The wagering telemetry data 150 is used by the process controller 104 to command the interactive controller 102 to automatically generate one or more wagering user interfaces 152 describing a state of wagered credit accumulation and/or loss for the hedged offer skill wagering system. When a player interacts with the one or more wagering user interfaces 152, wagering user interface telemetry data 150 is generated by the one or more wagering user interfaces 152 and communicated by the interactive controller 102 to the process controller 104 using interfaces 122 and 124.

In some embodiments, the wagering telemetry data 150 may include, but is not limited to, amounts of application credits, and/or interactive elements earned, lost or accumulated through interaction with the interactive application 110, and credits, application credits, and interactive elements amounts won, lost or accumulated as a result of an outcome of a skill wager proposition.

In some embodiments, the skill wager proposition data, interactive application command data, and/or resource data 108 are communicated to the wagering user interface generator 148 and used as a partial basis for generation of the wagering telemetry data 150 communicated to the interactive controller 102.

In various embodiments, the wagering user interface generator 148 also receives random component data that is used as a partial basis for generation of the wagering telemetry data 150 communicated to the interactive controller 102. In some embodiments, the random component data also includes data about one or more states of a wager of the skill wager proposition. In various such embodiments, the wagering user interface generator 148 generates a random component generation process display and/or random component state display using the one or more states of the random component. The random component generation process display and/or random component state display is included in the wagering telemetry data 150 that is communicated to the interactive controller 102. The wagering process display and/or wagering state display is automatically displayed by the interactive controller 102 using the one or more wagering user interfaces 152. In other such embodiments, the one or more states of the random component are communicated to the interactive controller 102 and the interactive controller 102 is instructed to automatically generate the random component generation process display and/or random component state display of the one or more wagering user interfaces 152 using the one or more states of the random component for display.

In some embodiments, an interactive controller generates a wagering user interface by executing commands that define processes of the wagering user interface where the commands are formatted in a scripting language. In operation, a wagering user interface generator of a process controller generates commands in the form of a script written in the scripting language. The script includes commands that describe how the interactive controller is to display wagering outcome data. The completed script is encoded as wagering telemetry data and communicated to the interactive controller by the process controller. The interactive controller receives the wagering telemetry data and parses the script encoded in the wagering telemetry data and executes the commands included in the script to generate the wagering user interface.

In many embodiments, an interactive controller generates a wagering user interface based on a document written in a document markup language that includes commands that define processes of the wagering user interface. In operation, a wagering user interface generator of a process controller generates a document composed in the document markup language. The document includes commands that describe how the interactive controller is to display wagering outcome data. The completed document is encoded as wagering telemetry data and communicated to the interactive controller by the process controller. The interactive controller receives the wagering telemetry data and parses the document encoded in the wagering telemetry data and executes the commands encoded into the document to generate the wagering user interface.

In some embodiments, an interactive controller generates a wagering user interface by executing commands that define processes of the wagering user interface. In operation, a wagering user interface generator of a process controller generates the commands and encodes the commands into wagering telemetry data that is communicated to the interactive controller by the process controller. The interactive controller receives the wagering telemetry data and executes the commands encoded in the wagering telemetry data to generate the wagering user interface.

In various embodiments, an interactive controller includes a data store of graphic and audio display resources that the interactive controller uses to generate a wagering user interface as described herein.

In many embodiments, a process controller communicates graphic and audio display resources as part of wagering telemetry data to an interactive controller. The interactive controller uses the graphic and audio display resources to generate a wagering user interface as described herein.

In many embodiments, the process controller 104 may additionally include various audit logs and activity meters.

The process controller 104 can further operatively connect to a metering subcontroller to determine an amount of credit or interactive elements available and other wagering metrics of a skill wager proposition. Thus, the process controller 104 may potentially affect an amount of credits in play for participation in the wagering events of the skill wager proposition provided by the wagering subcontroller. In some embodiments, the process controller 104 can also couple to a centralized server for exchanging various data related to players and the activities of the players during utilization of a hedged offer skill wagering system.

In a number of embodiments, communication of random component determination commands and skill wager proposition commands between the wagering subcontroller 136 and the process controller 104 can further be used to communicate various wagering control factors that the wagering subcontroller uses as input. Examples of wagering control factors include, but are not limited to, an amount of credits, amount of application credits, amount of interactive elements, or amounts of objects consumed wager, and/or a player's election to enter a jackpot round.

In many embodiments, two or more players can be engaged in using the interactive application 110 executed by the interactive controller 102. In various embodiments, a hedged offer skill wagering system can include an interactive application 110 that provides a skill-based interactive application that includes head-to-head play between a single player and a computing device, between two or more players against one another, or multiple players playing against a computer device and/or each other. In some embodiments, the interactive application 110 can be a skill-based interactive application where the player is not skillfully playing against the computer or any other player such as skill-based interactive applications where the player is effectively skillfully playing against himself or herself.

In some embodiments, the process controller 104 utilizes the one or more wagering user interfaces 152 to communicate certain interactive application data to the player, including but not limited to, club points, player status, control of the selection of choices, and messages which a player can find useful in order to adjust the interactive application experience or understand the wagering status of the player.

In some embodiments, the process controller 104 utilizes the one or more wagering user interfaces 152 to communicate aspects of a skill wager proposition to a player including, but not limited to, amount of credits, application credits, interactive elements, or objects in play, and amounts of credits, application credits, interactive elements, or objects available.

In a number of embodiments, the wagering subcontroller 136 can accept skill wager proposition factors including, but not limited to, modifications in the amount of credits, application credits, interactive elements, or objects wagered on each individual wagering event, entrance into a bonus round, and other factors. In several embodiments, the process controller 104 can communicate a number of factors back and forth to the wagering subcontroller, such that an increase/decrease in a wagered amount can be related to the change in player profile of the player in the interactive application. In this manner, a player can control a wager amount per wagering event in accordance with the skill wager proposition with the change mapping to a parameter or component that is applicable to the interactive application experience.

In some embodiments, the process controller 104 includes a session subcontroller 154 is used to regulate a hedged offer skill wagering system session.

In various embodiments, the session subcontroller 154 includes one or more session subcontroller interfaces that operatively connect the session subcontroller 154 to one or more wagering subcontrollers, metering subcontrollers and pooled bet subcontrollers through their respective interfaces.

In some embodiments, one or more of the session subcontroller interfaces implement a session subcontroller to device or server communication protocol employing an interprocess communication protocol so that the session subcontroller and one or more of an interactive controller, a wagering subcontroller, and/or a process controller may be implemented on the same device. In operation, the session subcontroller interfaces provide application programming interfaces or the like that are used by the session subcontroller to communicate outgoing data and receive incoming data by passing parameter data to another process or application running on the same device.

In some embodiments, one or more of the session subcontroller interfaces implement a session subcontroller communication protocol employing an interdevice communication protocol so that the session subcontroller may be implemented on a device separate from the one or more interactive controllers, the one or more process controllers and/or the one or more wagering subcontrollers. The interdevice protocol may utilize a wired communication bus or wireless connection as a physical layer. In various embodiments, one or more of the session subcontroller interfaces implement a session subcontroller communication protocol employing a networking protocol so that the process session subcontroller may be operatively connected to the one or more interactive controllers, the one or more process controllers, and/or the one or more wagering subcontrollers by a network. The networking protocol may utilize a wired communication bus or wireless connection as a physical layer. In many such embodiments, the network includes a cellular telephone network or the like and the one or more interactive controllers include a mobile device such as a smartphone or other device capable of using the telephone network. During operation, the one or more session subcontroller interfaces communicate outgoing data to an external device or server by encoding the data into a signal and transmitting the signal to the external device or server. The one or more session subcontroller interfaces receive incoming data from an external device or server by receiving a signal transmitted by the external device or server and decoding the signal to obtain the incoming data.

In various embodiments, components of the process controller 104 communicate session data to the session subcontroller. The session data may include, but is not limited to, player data, interactive controller data, pooled bet and side bet data, process controller data and wagering subcontroller data used by the session subcontroller to regulate a hedged offer skill wagering system session.

In some embodiments, the session subcontroller 154 may also assert control of a hedged offer skill wagering system session by communicating session control data to components of the process controller 104. Such control may include, but is not limited to, commanding the process controller 104 to end a hedged offer skill wagering system session, initiating wagering in a hedged offer skill wagering system session, ending wagering in a hedged offer skill wagering system session but not ending a player's use of the interactive application portion of the hedged offer skill wagering system, and changing from real credit wagering in a hedged offer skill wagering system to virtual credit wagering, or vice versa.

In many embodiments, the session subcontroller 154 manages player profiles for a plurality of players. The session subcontroller 154 stores and manages data about players in order to provide authentication and authorization of players of the hedged offer skill wagering system 100. In some embodiments, the session subcontroller 154 also manages geolocation information to ensure that the hedged offer skill wagering system 100 is only used by players in jurisdictions were wagering is approved. In various embodiments, the session subcontroller 154 stores application credits that are associated with the player's use of the interactive application of the hedged offer skill wagering system 100.

In some embodiments, the session subcontroller 154 communicates player and session management data to the player using a management user interface (not shown) of the interactive controller. The player interacts with the management user interface and the management user interface generates management telemetry data that is communicated to the session subcontroller 154 via interfaces 122 and 124.

In some embodiments, the wagering subcontroller 136 communicates wagering session data to the session subcontroller 154. In various embodiments, the session subcontroller communicates wagering session control data to the wagering subcontroller 136.

In some embodiments, a process controller operates as an interface between an interactive controller and a wagering subcontroller. By virtue of this construction, the wagering subcontroller is isolated from the interactive controller allowing the interactive controller to operate in an unregulated environment while allowing the wagering subcontroller to operate in a regulated environment.

In some embodiments, a single wagering subcontroller may provide services to two or more interactive controllers and/or two or more process controllers, thus allowing a hedged offer skill wagering system to operate over a large range of scaling.

In various embodiments, multiple types of interactive controllers using different operating systems may be interfaced to a single type of process controller and/or wagering subcontroller without requiring customization of the process controller and/or the wagering subcontroller.

In many embodiments, an interactive controller may be provided as a player device under control of a player while maintaining the wagering subcontroller in an environment under the control of a regulated operator of wagering equipment.

In several embodiments, data communicated between the controllers may be encrypted to increase security of the hedged offer skill wagering system.

In some embodiments, a process controller isolates random component logic 134 as regulated logic and skill wager proposition logic 132 as unregulated logic from a regulated wagering subcontroller, thus allowing errors in the skill wager proposition logic and/or random component logic to be corrected, new skill wager proposition logic and/or random component logic to be used, or modifications to be made to the skill wager proposition logic and/or random component logic without a need for regulatory approval.

In various embodiments, an interactive application may require extensive processing resources from an interactive controller leaving few processing resources for the functions performed by a process controller and/or a wagering subcontroller. By virtue of the architecture described herein, processing loads may be distributed across multiple devices such that operations of the interactive controller may be dedicated to the interactive application and the processes of the process controller and/or wagering subcontroller are not burdened by the requirements of the interactive application.

In many embodiments, a hedged offer skill wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of a hedged offer skill wagering system are distributed in close proximity to each other and communicate using a local area network and/or a communication bus. In several embodiments, an interactive controller and a process controller of a hedged offer skill wagering system are in a common location and communicate with an external wagering subcontroller. In some embodiments, a process controller and a wagering subcontroller of a hedged offer skill wagering system are in a common location and communicate with an external interactive controller. In many embodiments, an interactive controller, a process controller, and a wagering subcontroller of a hedged offer skill wagering system are located in a common location. In some embodiments, a session subcontroller is located in a common location with a process controller and/or a wagering subcontroller.

In various embodiments, these multiple devices can be constructed from or configured using a single device or a plurality of devices such that a hedged offer skill wagering system is executed as a system in a virtualized space such as, but not limited to, where a wagering subcontroller and a process controller are large scale centralized servers in the cloud operatively connected to widely distributed interactive controllers via a wide area network such as the Internet or a local area network. In such embodiments, the components of a hedged offer skill wagering system may communicate using a networking protocol or other type of device-to-device communications protocol.

In some embodiments, a hedged offer skill wagering system is deployed over a local area network or a wide area network in an interactive configuration. An interactive configuration of a hedged offer skill wagering system includes an interactive controller operatively connected by a network to a process controller and a wagering subcontroller.

In some embodiments, a hedged offer skill wagering system is deployed over a local area network or a wide area network in a mobile configuration. A mobile configuration of a hedged offer skill wagering system is useful for deployment over a wireless communication network, such as a wireless local area network or a wireless telecommunications network. A mobile configuration of a hedged offer skill wagering system includes an interactive controller operatively connected by a wireless network to a process controller and a wagering subcontroller.

In several embodiments, a centralized process controller is operatively connected to one or more interactive controllers and one or more wagering subcontrollers using a communication link. The centralized process controller can perform the functionality of a process controller across various hedged offer skill wagering systems.

In numerous embodiments, an interactive application server provides a host for managing head-to-head play operating over a network of interactive controllers connected to the interactive application server using a communication link. The interactive application server provides an environment where players can compete directly with one another and interact with other players.

In some embodiments, the process controller 104 is operatively connected to a central determination controller (not shown). In operation, when a wagering subcontroller of the process controller 104 needs to determine a random component, the wagering subcontroller communicates a request to the central determination controller for the random component. The central determination controller receives the random component request and generates a random component in response to the random component request. The central determination controller communicates data of the random component to the process controller 104. The processing controller 104 receives the data of the random component and utilizes the random component as described herein. In some embodiments, the random component is drawn from a pool of pre-determined random results.

In many embodiments, the credit processing controller 105 operatively connects to one or more credit input devices for generating incoming credit data from a credit input. Credit inputs can include, but are not limited to, credit items used to transfer credits. The incoming credit data are communicated by the credit processing controller 105 to the metering subcontroller 140. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing controller 105 includes one or more credit output devices 146 for generating a credit output based on outgoing credit data 192 communicated from the wagering subcontroller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing controller 105 is operatively connected to, and communicates with, a TITO system or the like to determine incoming credit data representing amounts of credits to be transferred into the hedged offer skill wagering system and to determine outgoing credit data representing amounts of credits to be transferred out of the hedged offer skill wagering system. In operation, the credit processing controller 105 communicates with a connected credit input device, such as a bill validator/ticket scanner, used to scan a credit input in the form of a TITO ticket having indicia of credit account data of a credit account of the TITO system. The credit processing controller 105 communicates the credit account data to the TITO system. The TITO system uses the credit account data to determine an amount of credits to transfer to the credit processing controller 105, and thus to the metering subcontroller 140 of the process controller 104. The TITO system communicates the amount of credits to the credit processing controller 105. The credit processing controller 105 communicates the amount of credits as incoming credit data to the metering subcontroller 140 and the metering subcontroller 140 credits one or more credit meters 142 with the amount of credits so that the credits can be used when a player makes wagers using the hedged offer skill wagering system 100.

In many embodiments, the credit processing controller 105 is operatively connected to a bill validator/ticket scanner as one of the one or more credit input devices 144. The credit processing controller 105 communicates with the bill validator/ticket scanner to scan currency used as a credit input to determine an amount of credits as incoming credit data to transfer credit to one or more credit meters 110 associated with one or more players. The skill metering subcontroller 140 credits the one or more credit meters 110 with the amount of credits so that the credits can be used when a player makes wagers using the hedged offer skill wagering system 100.

In some embodiments, the credit processing controller 105 can use a TITO system along with a ticket or voucher printer as one of the one or more credit output devices 146 to generate a TITO ticket as a credit output for a player. In operation, the credit processing controller 105 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing controller 105. The credit processing controller 105 uses the ticket or voucher printer to print indicia of the credit account data onto a TITO ticket or voucher as a credit output.

In various embodiments, a credit processing interface 156 resident in the credit processing controller 105 provides an interface between the credit processing controller 156 and the process controller 104.

In some embodiments, the application control interface 156 implements a credit processing controller to process controller communication protocol employing an interprocess communication protocol so that the interactive controller 104 and the credit processing controller 105 may be implemented on the same device. In operation, the credit processing interface 156 provides application programming interfaces that are used by the credit processing controller 105 to communicate outgoing data and receive incoming data by passing parameter data to another process or application.

In some embodiments, the credit processing interface 156 implements an interactive controller to credit processing controller communication protocol employing an interdevice communication protocol so that the interactive controller and the credit processing controller may be implemented on different devices. The interdevice protocol may utilize a wired communication bus or wireless connection as a physical layer.

In various embodiments, the credit processing interface 156 implements an interactive controller to credit processing controller communication protocol employing a networking protocol so that the process controller 104 and the credit processing controller 105 may be implemented on different devices connected by a network. The networking protocol may utilize a wired communication bus or wireless connection as a physical layer. During operation, the credit processing interface 156 communicates outgoing data to an external device by encoding the data into a signal and transmitting the signal to an external device. The application control interface receives incoming data from an external device by receiving a signal transmitted by the external device and decoding the signal to obtain the incoming data.

In various embodiments, the credit processing controller 105 provides an interface to an electronic payment management system (not shown) such as an electronic wallet or the like. The electronic payment system provides credit account data that is used for generating incoming credit data as a credit input and outgoing credit data as a credit output.

In many embodiments, the process controller 104 is further connected to one or more side betting terminals providing user interfaces that enable spectators of a player using the hedged offer skill wagering system to make side bets based on the performance of the player.

In various embodiments, the process controller 104 may be operatively connected to a progressive controller along (not shown) with one or more other process controllers of one or more other hedged offer skill wagering systems. The progressive controller provides services for the collection and provision of credits used by the process controller to provide components that have a progressive or pooling component.

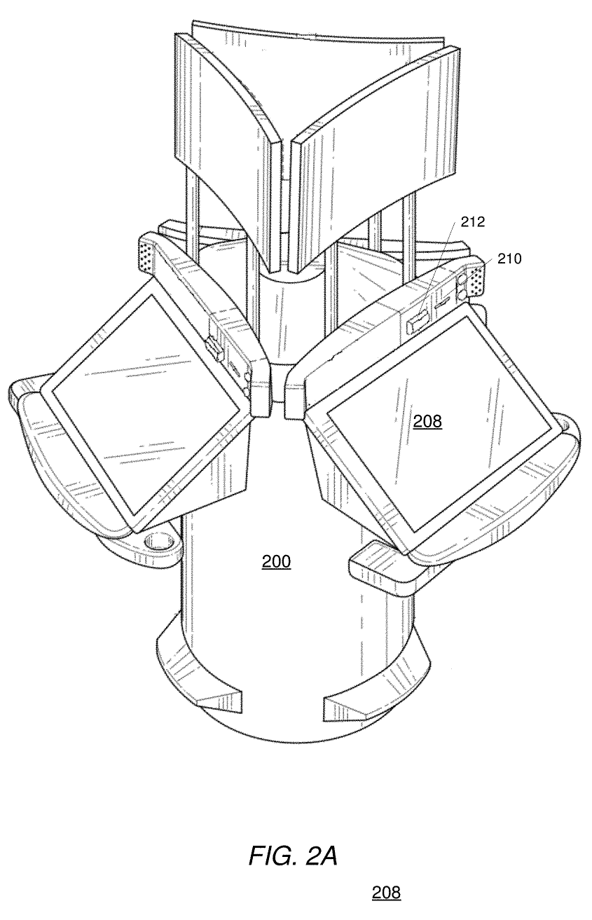

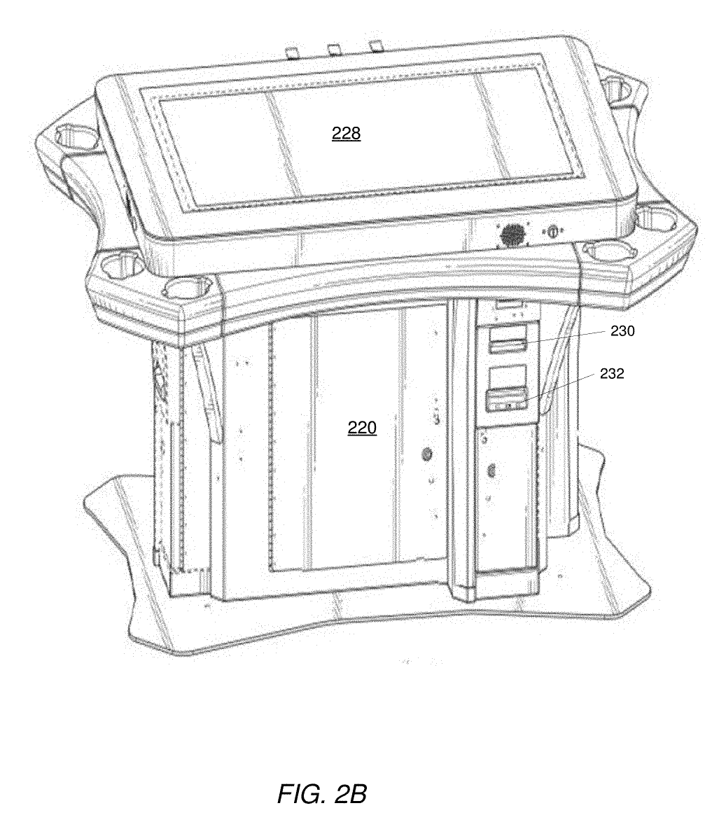

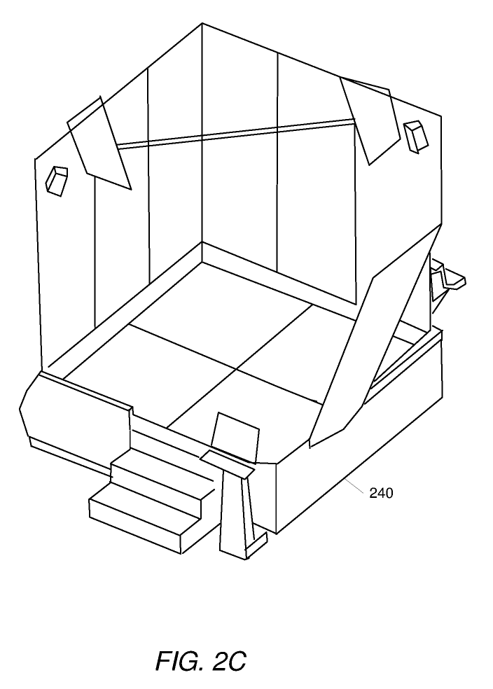

FIG. 2A is a diagram of an electronic gaming machine configuration of a hedged offer skill wagering system in accordance with various embodiments of the invention. Electronic gaming machine configurations of a hedged offer skill wagering system include, but are not limited to, electronic gaming machines such as slot machines, table games, video arcade consoles and the like. An electronic gaming machine configuration of a hedged offer skill wagering system 200 includes an interactive controller, such as interactive controller 100 of FIG. 1, a process controller, such as process controller 104 of FIG. 1, and a credit processing controller, such as credit processing controller 105, as described herein located in an enclosure such as a housing, cabinet, casing or the like. The enclosure may further include one or more player accessible openings or surfaces that may be used to mount one or more player accessible user input devices and player accessible user output devices 208, one or more player accessible credit input devices 210 and one or more player accessible credit output devices 212. The interactive controller communicates with the user input devices to detect player interactions with the hedged offer skill wagering system and commands and controls the user output devices to provide a user interface to one or more players of the hedged offer skill wagering system as described herein. The process controller communicates with the credit processing controller or player credit processing devices 210 and 212 to transfer credits into and out of the hedged offer skill wagering system as described herein.

FIG. 2B is a diagram of a multiplayer electronic gaming machine configuration of a hedged offer skill wagering system in accordance with various embodiments of the invention. Types of a multiplayer electronic gaming machine configuration a hedged offer skill wagering system include, but are not limited to, multiplayer electronic gaming machines, multiplayer slot machines, multiplayer table gaming devices, multiplayer video arcade consoles and the like. A multiplayer electronic gaming machine configuration of a hedged offer skill wagering system 220 includes an interactive controller, such as interactive controller 100 of FIG. 1, a process controller, such as process controller 104 of FIG. 1, and a credit processing controller, such as credit processing controller 105, as described herein located in an enclosure such as a housing, cabinet, casing or the like. The enclosure may further include one or more player accessible openings or surfaces that may be used to mount one or more player accessible user input devices and user output devices 228, one or more player accessible credit input devices 230 and one or more player accessible credit output devices 212.

In some embodiments, two or more sets of credit input devices and two or more credit output devices are provided so that each player of the multiplayer electronic gaming machine configuration of a hedged offer skill wagering system 220 can have an associated set of credit input devices and credit output devices.

The interactive controller communicates with the user input devices to detect player interactions with the hedged offer skill wagering system and commands and controls the user output devices to provide a user interface to one or more players of the hedged offer skill wagering system as described herein. The process controller communicates with the credit processing controller or player credit processing devices 230 and 232 to transfer credits into and out of the hedged offer skill wagering system as described herein.

FIG. 2C is a diagram of virtual reality electronic gaming machine configuration of a hedged offer skill wagering system in accordance with various embodiments of the invention. Types of a virtual reality gaming machine configuration of a hedged offer skill wagering system include, but are not limited to, virtual reality gaming machines, virtual reality slot machines, virtual reality gaming devices, virtual reality arcade consoles and the like. A virtual reality gaming machine configuration of a hedged offer skill wagering system includes an interactive controller, such as interactive controller 100 of FIG. 1, a process controller, such as process controller 104 of FIG. 1, and a credit processing controller, such as credit processing controller 105 of FIG. 1, as described herein, located in an enclosure such as a housing, cabinet, casing or the like. The enclosure may further include one or more player accessible openings or surfaces that may be used to mount one or more player accessible user input devices and user output devices, one or more player accessible credit input devices and one or more player accessible credit output devices.

A virtual reality electronic gaming machine configuration of a hedged offer skill wagering system further includes a player area having virtual reality sensors for sensing player interactions and/or player movements within the player area, a player headset having a stereoscopic visual display for presentation of a stereoscopic presentation to a player, headphones for presenting a stereophonic sound presentation to a player, and one or more subwoofers for providing a hepatic or low frequency auditory presentation to the player.

The interactive controller communicates with the user input devices to detect player interactions with the virtual reality hedged offer skill wagering system and commands and controls the user output devices to provide a user interface to one or more players of the virtual reality hedged offer skill wagering system as described herein. The process controller communicates with the credit processing controller or player credit processing devices and to transfer credits into and out of the hedged offer skill wagering system as described herein.

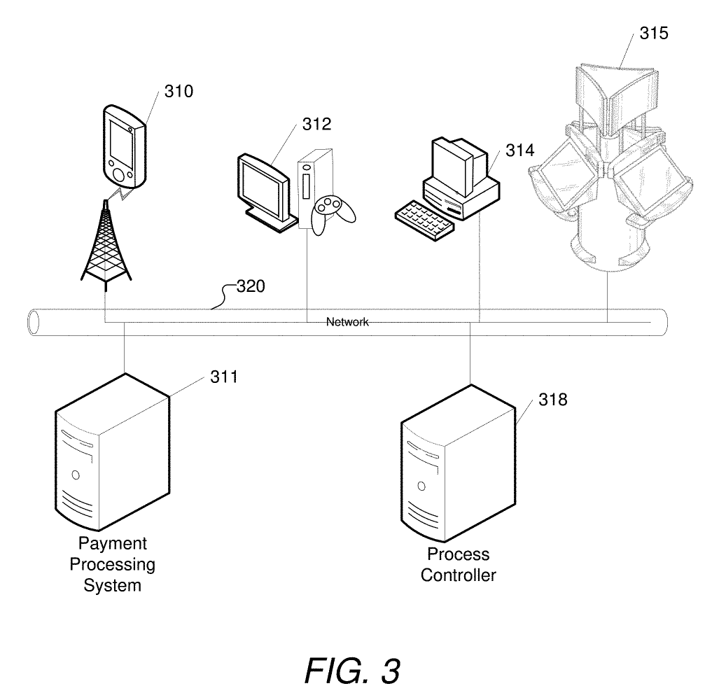

FIG. 3 is a diagram of distributed hedged offer skill wagering systems in accordance with various embodiments of the invention. An interactive controller, such as interactive controller 102 of FIG. 1, may be constructed from or configured using one or more processing devices that perform the operations of the interactive controller. An interactive controller in a distributed hedged offer skill wagering system may be constructed from or configured using any processing device having sufficient processing and communication capabilities that may be that perform the processes of an interactive controller in accordance with various embodiments of the invention. In some embodiments, the construction or configuration of the interactive controller may be achieved through the use of an application control interface, such as application control interface 122 of FIG. 1, and/or through the use of an interactive application, such as interactive application 110 of FIG. 1.

In some embodiments, an interactive controller may be constructed from or configured using an electronic gaming machine 315, such as a slot machine or the like. The electronic gaming machine 315 may be physically located in various types of gaming establishments.

In many embodiments, an interactive controller may be constructed from or configured using a portable device 310. The portable device 310 is a device that may wirelessly connect to a network. Examples of portable devices include, but are not limited to, a tablet computer, a personal digital assistant, and a smartphone.

In some embodiments, an interactive controller may be constructed from or configured using a gaming console 312.

In various embodiments, an interactive controller may be constructed from or configured using a personal computer 314.

In some embodiments, one or more processing devices, such as devices 310, 312, 314, and 315 may be used to construct a complete hedged offer skill wagering system and may be operatively connected using a communication link to a session and/or management controller.

Some hedged offer skill wagering systems in accordance with many embodiments of the invention can be distributed across a plurality of devices in various configurations. One or more interactive controllers of a distributed hedged offer skill wagering system, such as but not limited to, a mobile or wireless device 310, a gaming console 312, a personal computer 314, and an electronic gaming machine 315 are operatively connected with a process controller 318 of a distributed hedged offer skill wagering system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an interactive controller and a process controller as described herein are executed on the individual interactive controllers 310, 312, 314, 315, and a virtual reality gaming machine while one or more processes of a process controller as described herein can be executed by the process controller 318.

In many embodiments, a distributed hedged offer skill wagering system and may be operatively connected using a communication link to a session controller (not shown), that performs the processes of a session subcontroller as described herein.

In several embodiments, a distributed hedged offer skill wagering system and may be operatively connected using a communication link to credit processing controller 311, that performs the processes of one or more credit processing controllers as described herein.

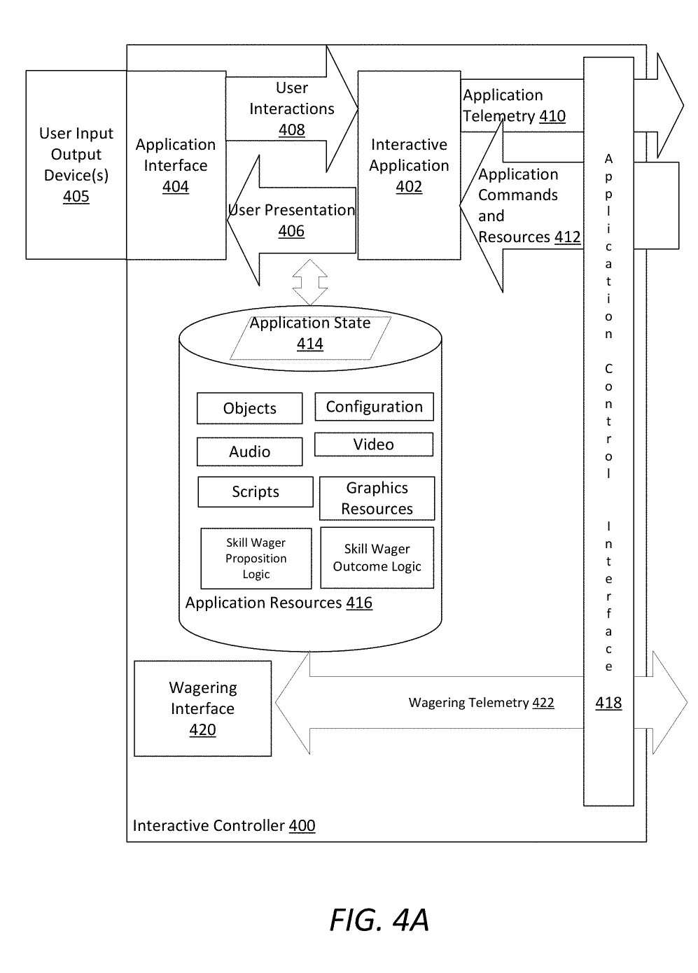

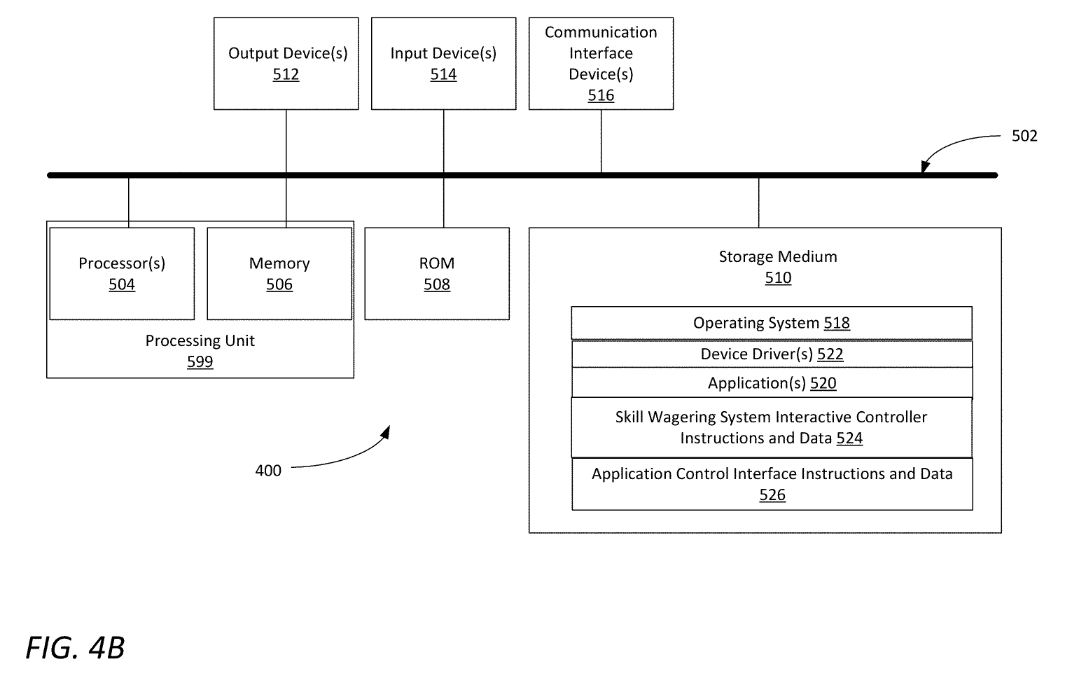

Referring now to FIG. 4A, an interactive controller 400, suitable for use as interactive controller 102 of FIG. 1, provides an execution environment for an interactive application 402 of a hedged offer skill wagering system. In several embodiments, an interactive controller 400 of a hedged offer skill wagering system provides an interactive application 402 that generates an application interface 404 for interaction with by a player. The interactive application 402 generates a player presentation 406 that is presented to the player through the application interface 404 using one or more player input and output devices 405. The player presentation 406 may include audio features, visual features or tactile features, or any combination of these features. In various embodiments, the application interface 404 utilizes one or more user interface input and output devices 405 so that a player can interact with the player presentation 406. In various embodiments, user interface input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user interface output devices include, but are not limited to: audio output devices such as speakers, headphones, earbuds, and the like; visual output devices such as lights, video displays and the like; and tactile devices such as rumble pads, hepatic touch screens, buttons, keys and the like. The player's interactions 408 are included by the interactive application 402 in application telemetry data 410 that is communicated by interactive controller 400 to various other components of a hedged offer skill wagering system as described herein. The interactive application 402 receives application commands and resources 412 communicated from various other components of a hedged offer skill wagering system as described herein. In some embodiments, the application telemetry data 410 may include player interactions with objects of the interactive application and a skill wager outcome for a skill wager proposition presented to the player by the interactive application 402.

In some embodiments, various components of the interactive application 402 can read data from an application state 414 in order to provide one or more features of the interactive application. In various embodiments, components of the interactive application 402 can include, but are not limited to: a physics engine; a rules engine; an audio engine; a graphics engine and the like. The physics engine is used to simulate physical interactions between virtual objects in the interactive application 402. The rules engine implements the rules of the interactive application and a random number generator that may be used for influencing or determining certain variables and/or outcomes to provide a randomizing influence on the operations of the interactive application. The graphics engine is used to generate a visual representation of the interactive application state to the player. The audio engine is used to generate an audio representation of the interactive application state to the player.

During operation, the interactive application reads and writes application resources 416 stored on a data store of the interactive controller host. The application resources 416 may include objects having graphics and/or control logic used to provide application environment objects of the interactive application. In various embodiments, the resources may also include, but are not limited to, video files that are used to generate a portion of the player presentation; audio files used to generate music, sound effects, etc. within the interactive application; configuration files used to configure the features of the interactive application; scripts or other types of control code used to provide various features of the interactive application; graphics resources such as textures, objects, etc. that are used by a graphics engine to render objects displayed in an interactive application; skill wager proposition logic used to generate a skill wager proposition for presentation to one or more players as described herein; and skill wager outcome logic for determining a skill wager outcome based on player interactions of one or more players as described herein.

In operation, components of the interactive application 402 read portions of the application state 414 and generate the player presentation 406 for the player that is presented to the player using the user interface 404. The player perceives the player presentation and provides player interactions 408 using the user input devices. The corresponding player interactions are received as player actions or inputs by various components of the interactive application 402. The interactive application 402 translates the player actions into interactions with the virtual objects of the application environment stored in the application state 414. Components of the interactive application use the player interactions with the virtual objects of the interactive application and the interactive application state 414 to update the application state 414 and update the player presentation 406 presented to the player. The process loops continuously while the player interacts with the interactive application of the hedged offer skill wagering system.

The interactive controller 400 provides one or more interfaces 418 between the interactive controller 400 and other components of a hedged offer skill wagering system, such as, but not limited to, a process controller. The interactive controller 400 and the other hedged offer skill wagering system components communicate with each other using the interface. The interface may be used to pass various types of data, and to communicate and receive messages, status data, commands and the like. In certain embodiments, the interactive controller 400 and a process controller communicate application commands and resources 412 and application telemetry data 410. In some embodiments, the communications include requests by the process controller that the interactive controller 400 update the application state 414 using data provided by the process controller.

In many embodiments, communications between a process controller and the interactive controller 400 includes a request that the interactive controller 400 update one or more resources 416 using data provided by the process controller. In a number of embodiments, the interactive controller 400 provides all or a portion of the application state to the process controller. In some embodiments, the interactive controller 400 may also provide data about one or more of the application resources 416 to the process controller. In some embodiments, the communication includes player interactions that the interactive controller 400 communicates to the process controller. The player interactions may be low level player interactions with the user interface 404, such as manipulation of an input device, or may be high level player interactions with game world objects as determined by the interactive application. The player interactions may also include resultant actions such as modifications to the application state 414 or game resources 416 resulting from the player's interactions taken in the hedged offer skill wagering system interactive application. In some embodiments, player interactions include, but are not limited to, actions taken by entities such as non-player characters (NPCs) of the interactive application that act on behalf of or under the control of the player.

In various embodiments, the application commands and resources 412 include skill wager proposition application commands and/or resources used by the interactive application to generate a presentation of a skill wager proposition presented to a player and to determine a skill wager outcome based on the player's skillful interaction with the presentation of the skill wager proposition.

In some embodiments, the interactive controller 400 includes a wagering user interface 420 used to provide hedged offer skill wagering system telemetry data 422 to and from the player. The hedged offer skill wagering system telemetry data 422 from the hedged offer skill wagering system includes, but is not limited to, data used by the player to configure credit, application credit and interactive element wagers, and data about the chance-based proposition credits, application credits and interactive element wagers such as, but not limited to, credit, application credit and interactive element balances and credit, application credit and interactive element amounts wagered.

In some embodiments, the interactive controller includes one or more sensors (not shown). Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors (GPSs). The interactive controller 400 communicates sensor telemetry data to one or more components of the hedged offer skill wagering system.

Referring now to FIG. 4B, interactive controller 400 includes a bus 502 that provides an interface for one or more processors 504, random access memory (RAM) 506, read only memory (ROM) 508, machine-readable storage medium 510, one or more user output devices 512, one or more user input devices 514, and one or more communication interface devices 516.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an interactive controller processing unit 599. In some embodiments, the interactive controller processing unit includes one or more processors operatively connected to one or more of a RAM, ROM, and machine-readable storage medium; the one or more processors of the interactive controller processing unit receive instructions stored by the one or more of a RAM, ROM, and machine-readable storage medium via a bus; and the one or more processors execute the received instructions. In some embodiments, the interactive controller processing unit is an ASIC (Application-Specific Integrated Circuit). In some embodiments, the interactive controller processing unit is a SoC (System-on-Chip).

Examples of output devices 512 include, but are not limited to, display screens; light panels; and/or lighted displays. In accordance with particular embodiments, the one or more processors 504 are operatively connected to audio output devices such as, but not limited to: speakers; and/or sound amplifiers. In accordance with many of these embodiments, the one or more processors 504 are operatively connected to tactile output devices like vibrators, and/or manipulators.

Examples of user input devices 514 include, but are not limited to: tactile devices including but not limited to, keyboards, keypads, foot pads, touch screens, and/or trackballs; non-contact devices such as audio input devices; motion sensors and motion capture devices that the interactive controller can use to receive inputs from a player when the player interacts with the interactive controller; physiological sensors that monitor the physiology of the player; environmental sensors that monitor the physical environment of the interactive controller; accelerometers that monitor changes in motion of the interactive controller; and location sensors that monitor the location of the interactive controller such as global positioning sensors.

The one or more communication interface devices 516 provide one or more wired or wireless interfaces for communicating data and commands between the interactive controller 400 and other devices that may be included in a hedged offer skill wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive controller, such as but not limited to: an operating system 518; one or more device drivers 522; one or more application programs 520 including but not limited to an interactive application; and hedged offer skill wagering system interactive controller instructions and data 524 for use by the one or more processors 504 to provide the features of an interactive controller as described herein. In some embodiments, the machine-executable instructions further include application control interface/application control interface instructions and data 526 for use by the one or more processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the interactive controller 400 to provide the features of a hedged offer skill wagering system interactive controller as described herein

Although the interactive controller is described herein as being constructed from or configured using one or more processors and instructions stored and executed by hardware components, the interactive controller can be constructed from or configured using only hardware components in accordance with other embodiments. In addition, although the storage medium 510 is described as being operatively connected to the one or more processors through a bus, those skilled in the art of interactive controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the interactive controller 400 can be distributed across a plurality of different devices. In many such embodiments, an interactive controller of a hedged offer skill wagering system includes an interactive application server operatively connected to an interactive client using a communication link. The interactive application server and interactive application client cooperate to provide the features of an interactive controller as described herein.

In various embodiments, the interactive controller 400 may be used to construct other components of a hedged offer skill wagering system as described herein.

In some embodiments, components of an interactive controller and a process controller of a hedged offer skill wagering system may be constructed from or configured using a single device using processes that communicate using an interprocess communication protocol. In other such embodiments, the components of an interactive controller and a process controller of a hedged offer skill wagering system may communicate by passing messages, parameters or the like.

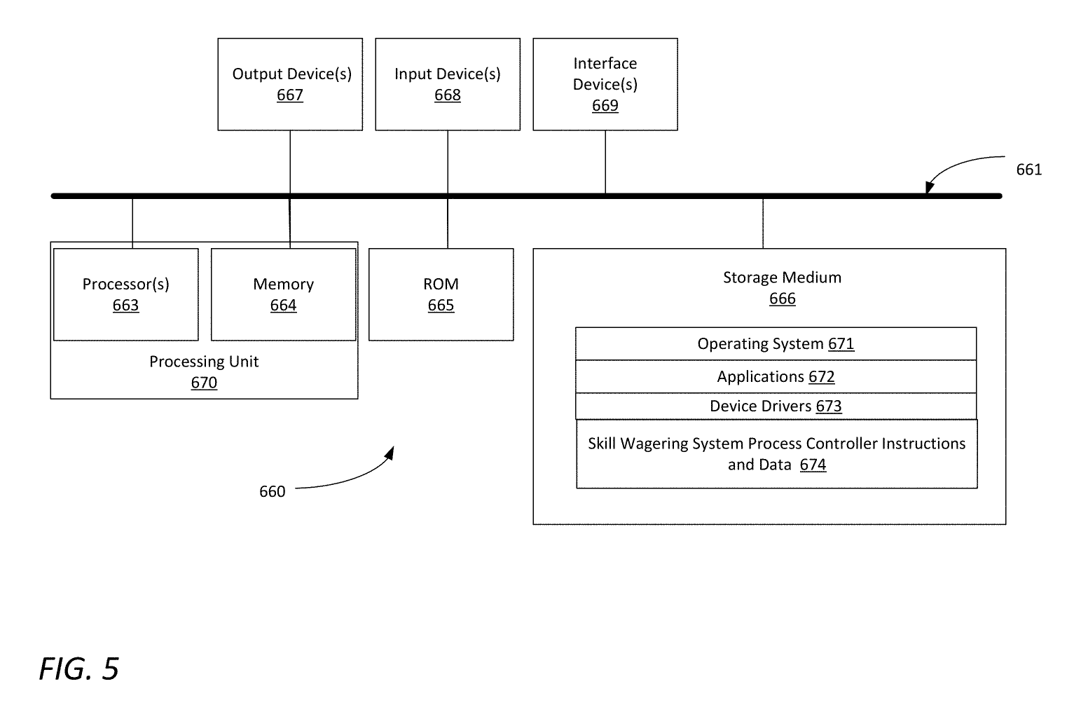

FIG. 5 is a diagram of a structure of a process controller, suitable for use as process controller 104 of FIG. 1, of a hedged offer skill wagering system in accordance with various embodiments of the invention. A process controller may be constructed from or configured using one or more processing devices that perform the operations of the process controller. In many embodiments, a process controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Process controller 660 includes a bus 661 providing an interface for one or more processors 663, random access memory (RAM) 664, read only memory (ROM) 665, machine-readable storage medium 666, one or more user output devices 667, one or more user input devices 668, and one or more communication interface and/or network interface devices 669.

The one or more processors 663 may take many forms, such as, but not limited to: a central processing unit (CPU); a multi-processor unit (MPU); an ARM processor; a programmable logic device; or the like.

Examples of output devices 667 include, include, but are not limited to: display screens; light panels; and/or lighted displays. In accordance with particular embodiments, the one or more processors 663 are operatively connected to audio output devices such as, but not limited to: speakers; and/or sound amplifiers. In accordance with many of these embodiments, the one or more processors 663 are operatively connected to tactile output devices like vibrators, and/or manipulators.

In the example embodiment, the one or more processors 663 and the random access memory (RAM) 664 form a process controller processing unit 670. In some embodiments, the process controller processing unit includes one or more processors operatively connected to one or more of a RAM, ROM, and machine-readable storage medium; the one or more processors of the process controller processing unit receive instructions stored by the one or more of a RAM, ROM, and machine-readable storage medium via a bus; and the one or more processors execute the received instructions. In some embodiments, the process controller processing unit is an ASIC (Application-Specific Integrated Circuit). In some embodiments, the process controller processing unit is a SoC (System-on-Chip).

Examples of user input devices 668 include, but are not limited to: tactile devices including but not limited to, keyboards, keypads, foot pads, touch screens, and/or trackballs; non-contact devices such as audio input devices; motion sensors and motion capture devices that the process controller can use to receive inputs from a player when the player interacts with the process controller 660.

The one or more communication interface and/or network interface devices 669 provide one or more wired or wireless interfaces for exchanging data and commands between the process controller 660 and other devices that may be included in a hedged offer skill wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 666 stores machine-executable instructions for various components of the process controller 660 such as, but not limited to: an operating system 671; one or more applications 672; one or more device drivers 673; and hedged offer skill wagering system process controller instructions and data 674 for use by the one or more processors 663 to provide the features of a process controller as described herein.

In various embodiments, the machine-readable storage medium 670 is one of a (or a combination of two or more of) a hard drive, a flash drive, a DVD, a CD, a flash storage, a solid state drive, a ROM, an EIEPROM, and the like.

In operation, the machine-executable instructions are loaded into memory 664 from the machine-readable storage medium 666, the ROM 665 or any other storage location. The respective machine-executable instructions are accessed by the one or more processors 663 via the bus 661, and then executed by the one or more processors 663. Data used by the one or more processors 663 are also stored in memory 664, and the one or more processors 663 access such data during execution of the machine-executable instructions. Execution of the machine-executable instructions causes the one or more processors 663 to control the process controller 660 to provide the features of a hedged offer skill wagering system process controller as described herein.

Although the process controller 660 is described herein as being constructed from or configured using one or more processors and instructions stored and executed by hardware components, the process controller can be composed of only hardware components in accordance with other embodiments. In addition, although the storage medium 666 is described as being operatively connected to the one or more processors through a bus, those skilled in the art of process controllers will understand that the storage medium can include removable media such as, but not limited to, a USB memory device, an optical CD ROM, magnetic media such as tape and disks. Also, in some embodiments, the storage medium 666 may be accessed by processor 663 through one of the interfaces or using a communication link. Furthermore, any of the user input devices or user output devices may be operatively connected to the one or more processors 663 via one of the interfaces or using a communication link.

In various embodiments, the process controller 660 may be used to construct other components of a hedged offer skill wagering system as described herein.

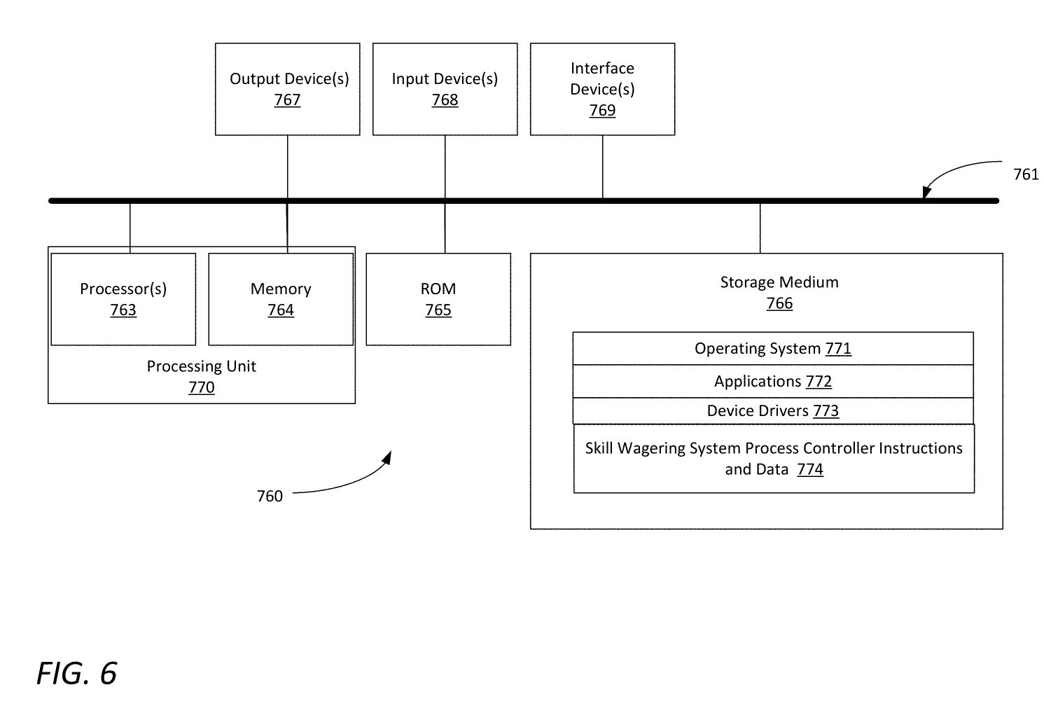

FIG. 6 is a diagram of a structure of a credit processing controller, suitable for use as credit processing controller 105 of FIG. 1, of a hedged offer skill wagering system in accordance with various embodiments of the invention. A credit processing controller may be constructed from or configured using one or more processing devices that perform the operations of the credit processing controller. In many embodiments, a credit processing controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Credit processing controller 760 includes a bus 761 providing an interface for one or more processors 763, random access memory (RAM) 764, read only memory (ROM) 765, machine-readable storage medium 766, one or more user output devices 767, one or more user input devices 768, and one or more communication interface and/or network interface devices 769.

The one or more processors 763 may take many forms, such as, but not limited to: a central processing unit (CPU); a multi-processor unit (MPU); an ARM processor; a programmable logic device; or the like.

Examples of output devices 767 include, include, but are not limited to: display screens; light panels; and/or lighted displays. In accordance with particular embodiments, the one or more processors 763 are operatively connected to audio output devices such as, but not limited to: speakers; and/or sound amplifiers. In accordance with many of these embodiments, the one or more processors 763 are operatively connected to tactile output devices like vibrators, and/or manipulators.

In the example embodiment, the one or more processors 763 and the random access memory (RAM) 764 form a credit processing controller processing unit 770. In some embodiments, the credit processing controller processing unit includes one or more processors operatively connected to one or more of a RAM, ROM, and machine-readable storage medium; the one or more processors of the credit processing controller processing unit receive instructions stored by the one or more of a RAM, ROM, and machine-readable storage medium via a bus; and the one or more processors execute the received instructions. In some embodiments, the credit processing controller processing unit is an ASIC (Application-Specific Integrated Circuit). In some embodiments, the credit processing controller processing unit is a SoC (System-on-Chip).

Examples of user input devices 768 include, but are not limited to: tactile devices including but not limited to, keyboards, keypads, foot pads, touch screens, and/or trackballs; non-contact devices such as audio input devices; motion sensors and motion capture devices that the credit processing controller can use to receive inputs from a player when the player interacts with the credit processing controller 760.

The one or more communication interface and/or network interface devices 769 provide one or more wired or wireless interfaces for exchanging data and commands between the credit processing controller 760 and other devices that may be included in a hedged offer skill wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 766 stores machine-executable instructions for various components of the credit processing controller 760 such as, but not limited to: an operating system 771; one or more applications 772; one or more device drivers 773; and credit processing controller instructions and data 774 for use by the one or more processors 763 to provide the features of a credit processing controller as described herein.

In various embodiments, the machine-readable storage medium 770 is one of a (or a combination of two or more of) a hard drive, a flash drive, a DVD, a CD, a flash storage, a solid state drive, a ROM, an EIEPROM, and the like.

In operation, the machine-executable instructions are loaded into memory 764 from the machine-readable storage medium 766, the ROM 765 or any other storage location. The respective machine-executable instructions are accessed by the one or more processors 763 via the bus 761, and then executed by the one or more processors 763. Data used by the one or more processors 763 are also stored in memory 764, and the one or more processors 763 access such data during execution of the machine-executable instructions. Execution of the machine-executable instructions causes the one or more processors 763 to control the credit processing controller 760 to provide the features of a hedged offer skill wagering system credit processing controller as described herein.

Although the credit processing controller 760 is described herein as being constructed from or configured using one or more processors and instructions stored and executed by hardware components, the credit processing controller can be composed of only hardware components in accordance with other embodiments. In addition, although the storage medium 766 is described as being operatively connected to the one or more processors through a bus, those skilled in the art of credit processing controllers will understand that the storage medium can include removable media such as, but not limited to, a USB memory device, an optical CD ROM, magnetic media such as tape and disks. Also, in some embodiments, the storage medium 766 may be accessed by processor 763 through one of the interfaces or using a communication link. Furthermore, any of the user input devices or user output devices may be operatively connected to the one or more processors 763 via one of the interfaces or using a communication link.

In various embodiments, the credit processing controller 760 may be used to construct other components of a hedged offer skill wagering system as described herein.

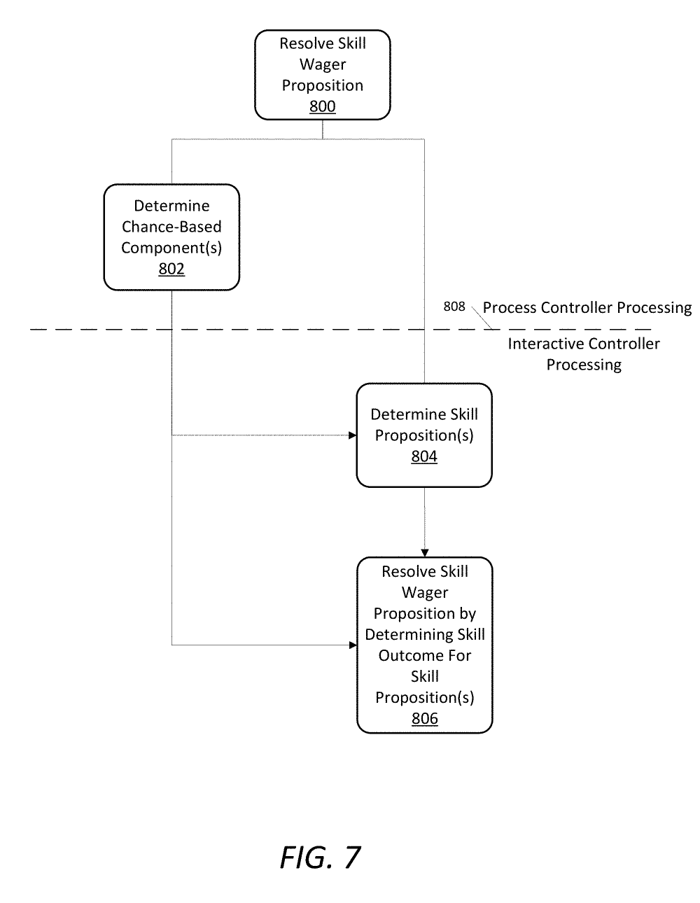

FIG. 7 is a block diagram of a process of a hedged offer skill wagering system during a wagering session in accordance with various embodiments of the invention. A hedged offer skill wagering system resolves 800 a skill wager proposition by determining 802 one or more random components using one or more random results, generating 804 one or more independent skill wager elements using the random components, and determining 806 a skill wager outcome using the one or more independent skill wager elements and an additional one or more random components. In slightly more detail, one or more random components are used to generate 804 one or more independent skill wager elements that will be used to shape a skill wager proposition presented to one or more players. The skill wager proposition is resolved 806 by determining a skill wager outcome for the skill wager proposition. During determination of the skill wager outcome, the one or more independent skill wager elements utilize one or more additional random components.

In some embodiments, as indicated by dashed line 808, a process controller of the hedged offer skill wagering system performs processing for determining 802 the random components while an interactive controller performs processing for generating 804 the one or more independent skill wager elements and determining 806 the skill wager outcome.

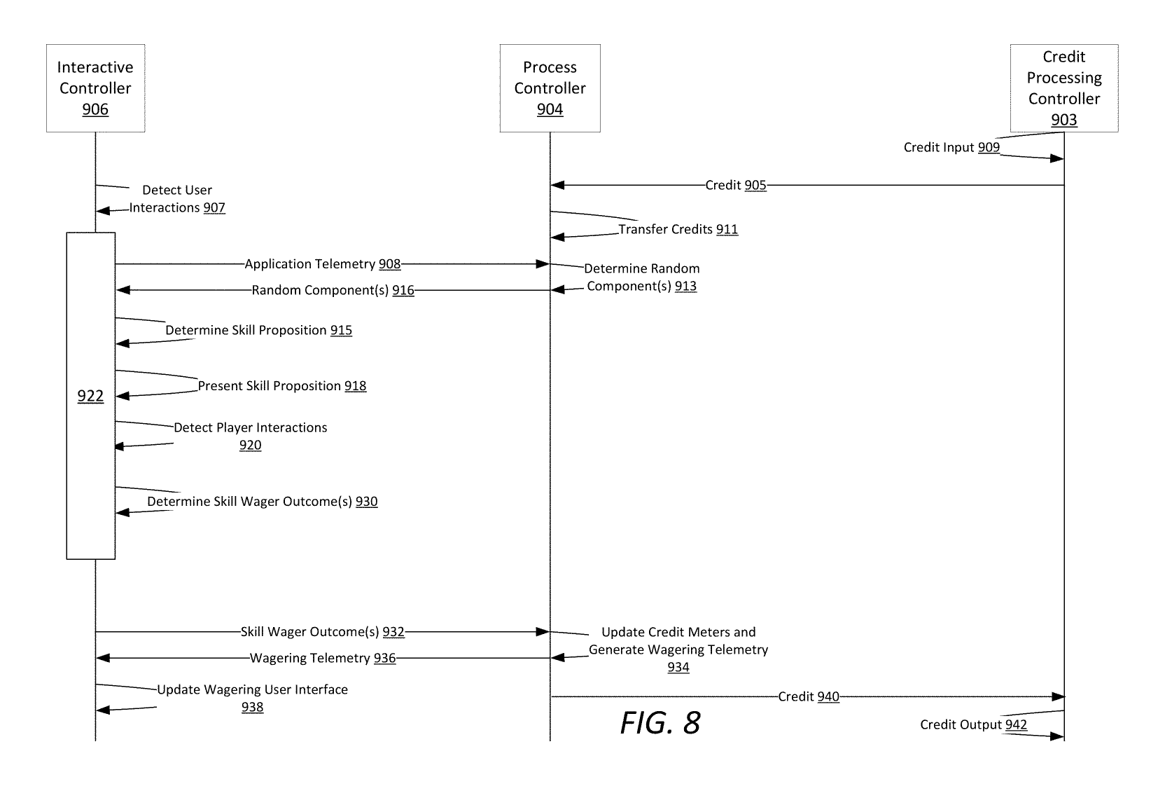

FIG. 8 is a sequence diagram of interactions between components of a hedged offer skill wagering system during a wagering session in accordance with various embodiments of the invention. The components of the hedged offer skill wagering system include a process controller 904, such as process controller 104 of FIG. 1, an interactive controller 906, such as interactive controller 102 of FIG. 1, and a credit processing controller 903, such as credit processing controller 105 of FIG. 1.

In some embodiments, the process includes a credit input 909 to the hedged offer skill wagering system as described herein. The credit processing controller 903 communicates data of the credit input 905 to the process controller 904 and the process controller 904 receives the incoming credit data 905. The process controller 904 uses the incoming credit data 905 to transfer credits 911 onto one or more player credit meters associated with one or more players of the hedged offer skill wagering system, thus transferring credits into the hedged offer skill wagering system and on to the one or more player credit meters.

The interactive controller 906 detects 907 one or more players performing a player interaction in an application interface of an interactive application provided by the interactive controller 906. The interactive controller 906 communicates application telemetry data 908 to the process controller 904. The application telemetry data 908 includes, but is not limited to, the player interaction detected by the interactive controller 906.

The process controller 904 receives the application telemetry data 908. Upon determination by the process controller 904 that the player interaction indicates initiation of a wagering session including a wagering process 922 in accordance with one or more skill wager propositions, the process controller 904 determines 913 one or more random components and communicates data of the one or more random components 916 to the interactive controller. The interactive controller uses the one or more random components to determine 915 one or more skill objectives of one or more skill propositions that are presented 918 to the one or more players. The presentation of the one or more skill propositions is presented to the one or more players in a user interface of the interactive application of the interactive controller 906. The presentation of the one or more skill propositions includes presenting to the one or more players through the user interface one or more interactive elements of a skill-based game. The one or more players interact with the one or more interactive elements while attempting to complete one or more skill objectives of the one or more skill objectives. The interactive controller 906 detects 920 player interactions by the one or more players with the interactive elements utilizing the one or more independent skill wager elements of the skill wager proposition. The interactive controller uses the player interactions and the one or more random outcomes to determine 930 one or more sill wager outcomes during the wagering session 922. In various embodiments, the wagering process continues for multiple iterations depending on a type of the skill wager proposition.

At the end of the wagering process, the interactive controller 906 communicates data of the one or more skill wager outcomes 924 determined during the wagering process 922 to the process controller 904. The process controller 904 receives the skill wager outcome data 932 and updates 934 the one or more player credit meters associated with the one or more players based on the skill wager outcome data. The process controller 904 generates 934 wagering telemetry data 936 using the data of the updated one or more credit meters. The process controller 904 communicates the wagering telemetry data 936 to the interactive controller 906. The interactive controller 906 receives the wagering telemetry data 936. The interactive controller 906 updates 938 a wagering user interface on a partial basis of the wagering telemetry data 936.

In many embodiments, upon determining that the wagering session is completed, such as by receiving a cashout communication from one or more players of the hedged offer skill wagering system, the process controller 904 transfers credits off of the one or more player credit meters, generates outgoing credit data 940 on the basis of the credits transferred off of the one or more player credit meters, and communicates the outgoing credit data 940 to the credit processing controller 903. The credit processing controller receives the outgoing credit data 940 and generates 942 a credit output as described herein, thus transferring credits off of the one or more player credit meters and out of the hedged offer skill wagering system.

In some embodiments, the process includes an application credit input to the hedged offer skill wagering system with the process controller 904 communicating with the credit processing controller 903 to receive incoming application credit data. The process controller 902 uses the incoming application credit data to transfer application credits onto one or more application credit meters associated with one or more players of the hedged offer skill wagering system, thus transferring application credits into the hedged offer skill wagering system and on to the one or more application credit meters. The process controller 904 uses the skill wager outcome data 932 to determine an amount of application credit to award to the one or more players based on the one or more players' skillful interactions with an interactive application executed by the interactive controller 906. Upon determining that the wagering session is completed, such as by receiving a cashout communication from one or more players of the hedged offer skill wagering system, the process controller 904 transfers application credits off of the one or more application credit meters, generates outgoing application credit data on the basis of the application credits transferred off of the one or more application credit meters, and communicates the outgoing application credit data to the credit processing controller 903. The credit processing controller receives the outgoing application credit data and generates an application credit output as described herein, thus transferring application credits off of the one or more application credit meters and out of the hedged offer skill wagering system.

In many embodiments, a multiplayer hedged offer skill wagering system presents an interactive application in the form of an interactive game to two or more players. At beginning of the interactive game, each of the two or more player's selects a hidden possible award value from a set of hidden possible award values. A the end of interactive game, a winning player is determined based on the relative performance of the players in the interactive game and the winner is presented with one or more hedged offer award values. The wining player can either select to receive the one or more hedged offer award values or select to receive the previously selected hidden possible award value that is then revealed to the winning player.

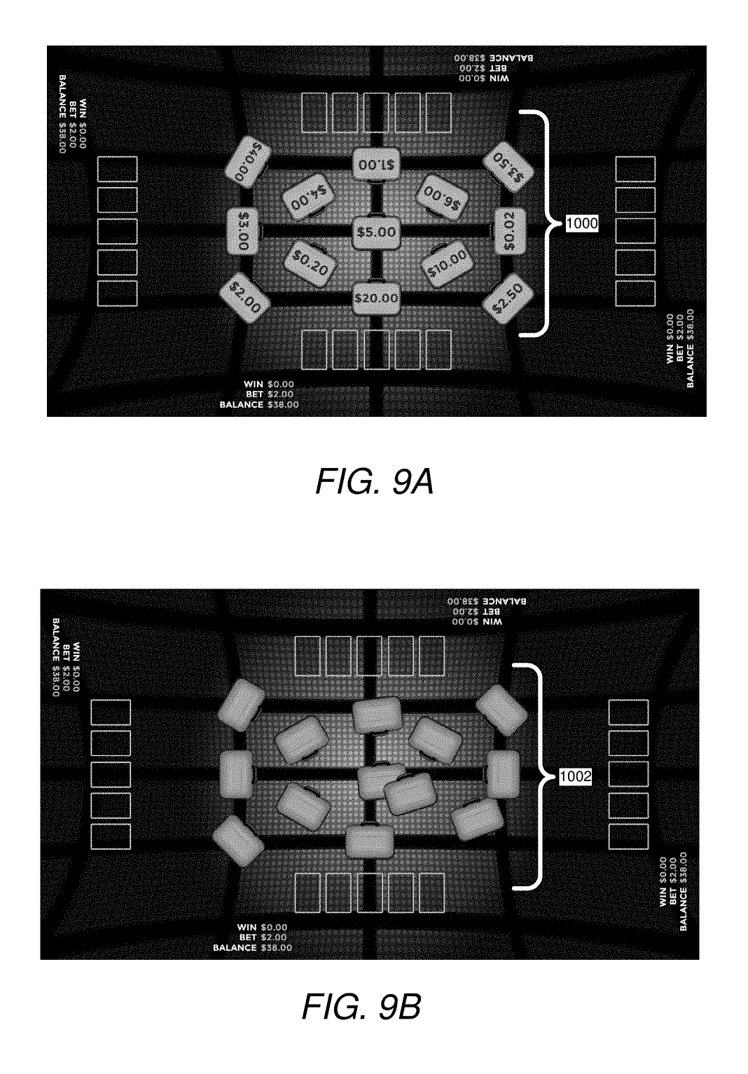

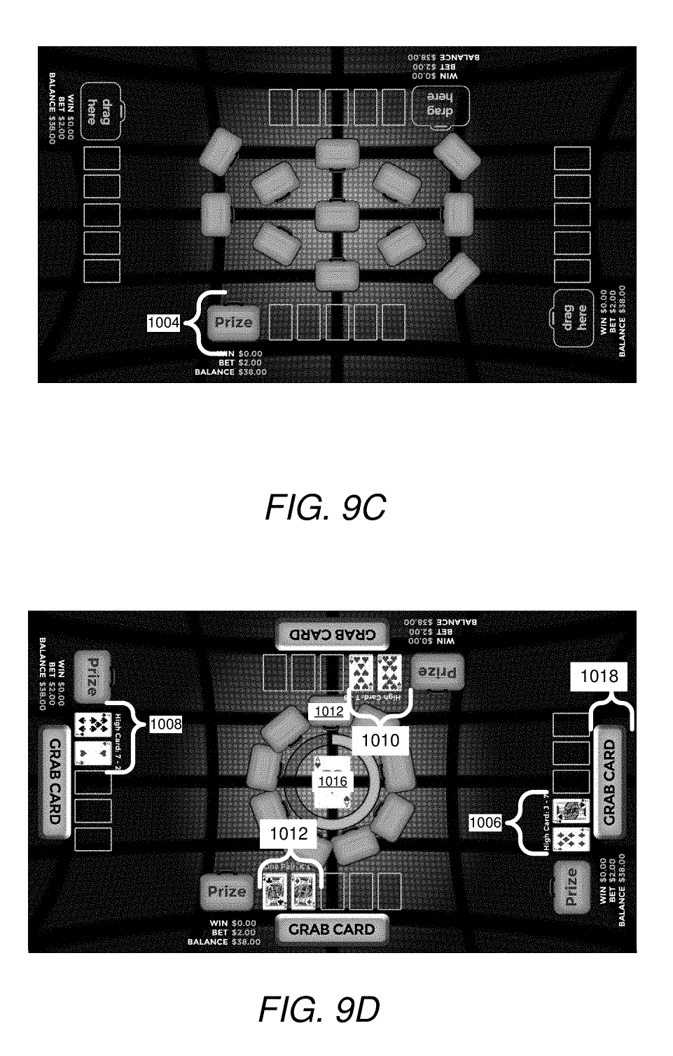

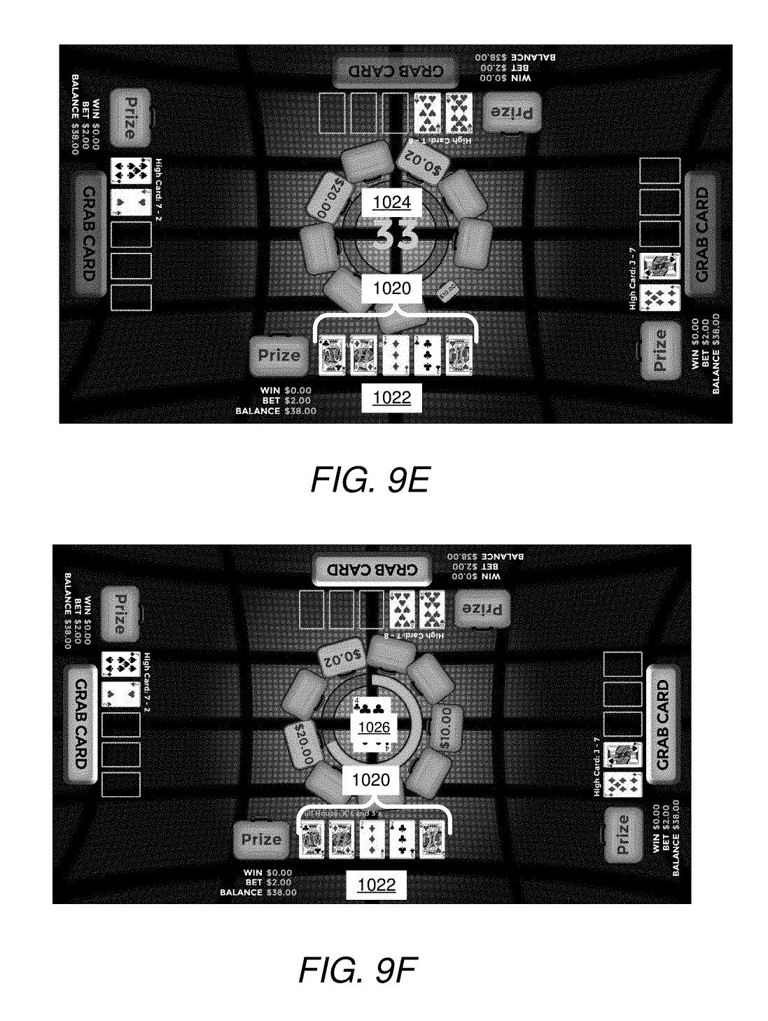

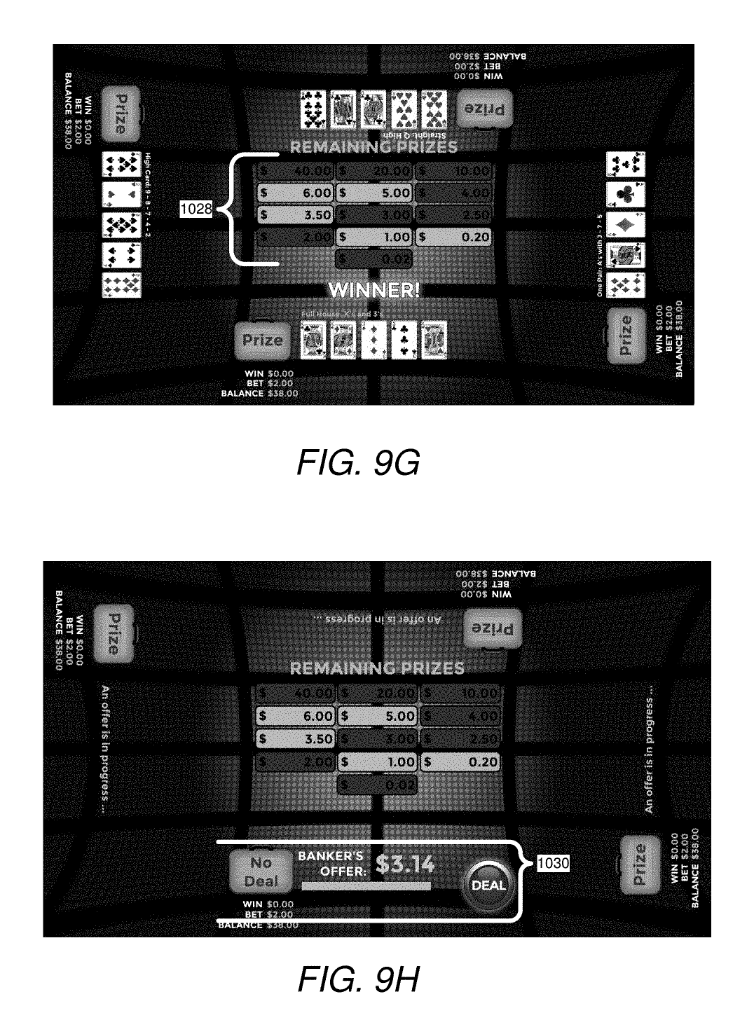

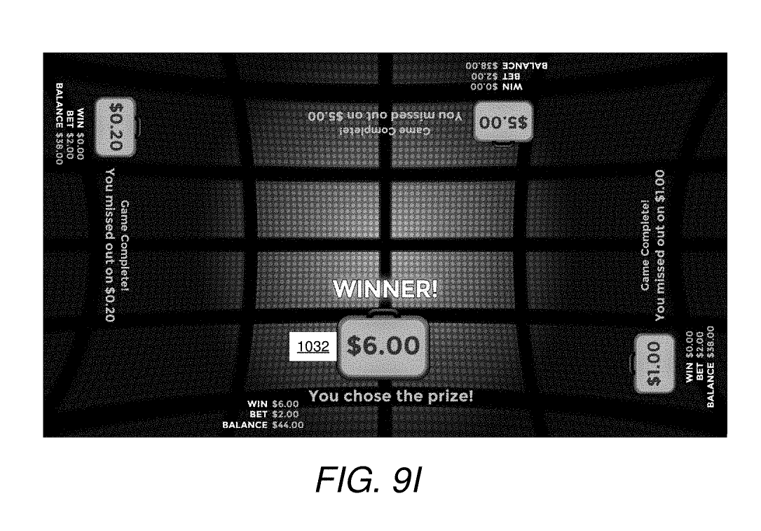

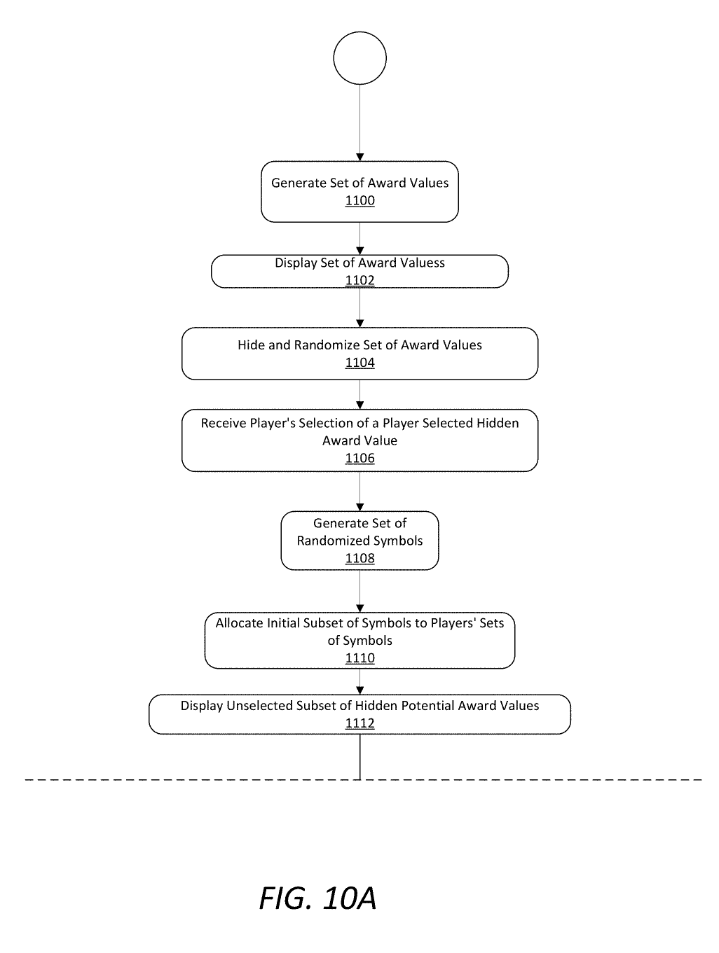

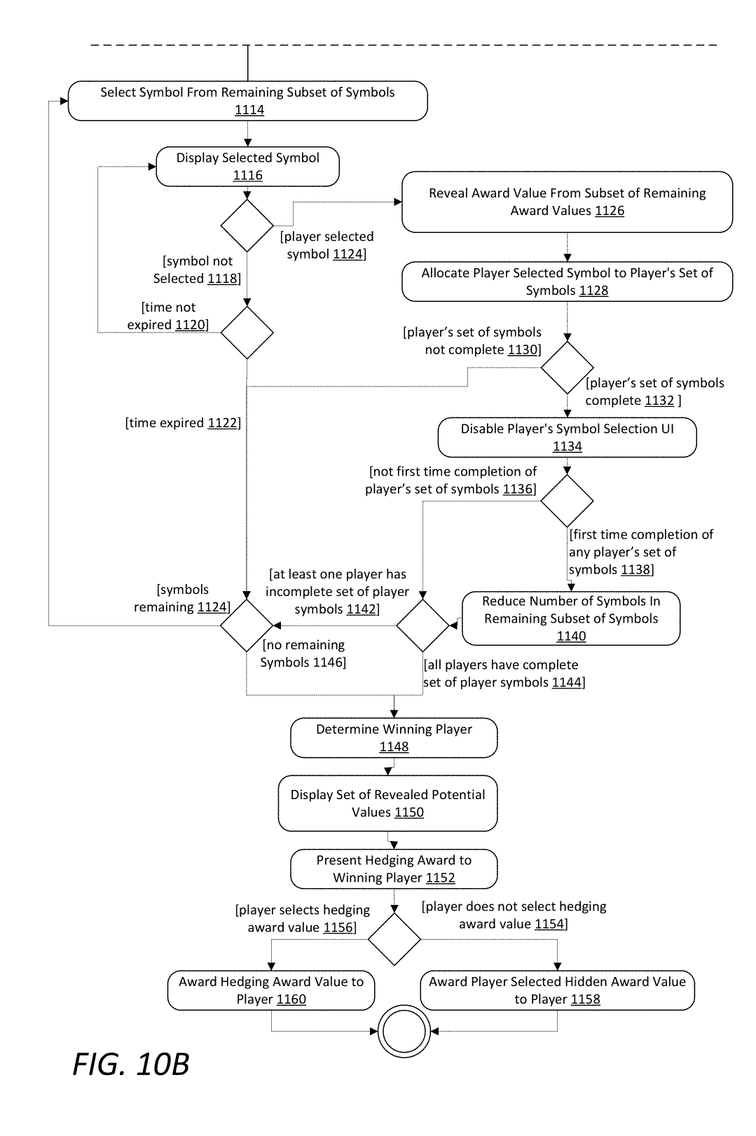

FIGS. 9A to 9I illustrate portions of a user interface of a multiplayer hedged offer skill wagering system in accordance with various embodiments of the invention. FIGS. 10A and 10B are activity diagrams of a multiplayer hedged offer skill wagering system in accordance with various embodiments of the invention.

Referring now to FIGS. 9A and 10A, a multiplayer hedged offer skill wagering system randomly generates 1100 a set of award values that may be awarded to one or more players of the hedged offer skill wagering system. The award values are generated using a random result and a paytable as described herein. The set of award values are displayed, 1102 and 1000, to two or more players at the initiation of a wagering session.

Referring now to FIGS. 9B and 10A, the set of award values are hidden, 1104 and 1002, from the two or more players and the positions of the award values are randomized using a random result.

Referring to FIGS. 9C and 10A, multiplayer hedged offer skill wagering system receives 1106 from each player of the two or more players a selection of one hidden award value of the hidden and randomized set of award values. Each selected award value is allocated 1004 to each respective player and displayed at the respective player's playing position in a hidden state signifying a respective potential award value that each player may be awarded if that player wins a subsequent multiplayer skill game.

Referring now to FIGS. 9D and 10A, a set of randomized symbols are generated 1108 and each of the two or more players is randomly allocated 1110 a respective initial subset of symbols to each player's respective player's set of symbols. Each of the allocated symbols, and 1006, 1008, 1010, and 1012, of each of the allocated initial subset of symbols is displayed at each respective player's player position but in a manner that each of the two or more players can see the allocated initial subset of symbols of each of the other two or more players. Icons, such as icon 1014, representing an unselected subset of the set of award values are displayed 1112 in an array around a central symbol display 1016. The central symbol display has a circular timer bar used to display in a relative manner an amount of time remaining for the two or more players to select a displayed symbol.

Referring now to FIGS. 9D and 10B, in operation, a symbol is selected 1114 by the multiplayer hedged offer skill wagering system from the remaining subset of symbols of the set of symbols not allocated to the two or more players in the initial subsets of symbols. The selected symbol is displayed 1116 in the central symbol display 1016 and the circular timer bar is used to display a remaining time period during which the two or more players are to attempt to select the displayed symbol. In addition, the icons arrayed around the central symbol display are highlighted in a sequence. If the multiplayer hedged offer skill wagering system detects 1122 that a player selects, using a selector button such as selector button 1018, the displayed symbol for allocation to the player's set of symbols, the multiplayer hedged offer skill wagering system reveals 1126 an award value associated with a currently highlighted icon to the two or more players and the multiplayer hedged offer skill wagering system allocates 1128 the selected symbol to the selecting player's set of symbols.

If the multiplayer hedged offer skill wagering system determines 1118 that no player has selected the displayed symbol at the expiration 1122 of the time period during which the two or more players are to attempt to select the displayed symbol, and the multiplayer hedged offer skill wagering system determines that there are symbols remaining 1124 in the remaining subset of symbols, the multiplayer hedged offer skill wagering system selects 1114 a new symbol from the remaining subset of symbols and displays the selected symbol to the two or more players as described herein. If the system determines 1120 that the time for selecting a symbol has not expired, the system continues displaying 1116 the selected symbol.

Referring now to FIGS. 9E, 9F, and 10B, when the selected symbol is allocated 1128 to the selecting player's player set of symbols, the multiplayer hedged offer skill wagering system determines if the player's set of symbols is complete 1020. If not, the multiplayer hedged offer skill wagering system continues 1130 the process of selecting and displaying symbols from the set of remaining symbols to the two or more players as described herein. If the multiplayer hedged offer skill wagering system determines that the set of player's symbol is complete 1132, the multiplayer hedged offer skill wagering system disables, 1134 and 1022, the player's user interface for selecting symbols so that the player does not interfere with subsequent symbol selections. A determination is made of whether or not this is the first time that a player of the two or more players has completed a player's set of symbols. If it is not the first time 1136, then the multiplayer hedged offer skill wagering system determines 1142 if at least one other player has an incomplete of player's set of symbols. If at least one player has an incomplete player's set of symbols, the multiplayer hedged offer skill wagering system continues to select and display 1026 symbols from the set of remaining symbols as described herein. If it is the first time that any player's set of symbols has been completed 1138, then the multiplayer hedged offer skill wagering system reduces 1140 the number of symbols in the remaining subset of symbols and displays the remaining number of symbols that will be displayed to the players 1024.

Referring now to FIGS. 9G and 10B, if the multiplayer hedged offer skill wagering system determines 1146 that there are no remaining symbols in the remaining subset of symbols, or that each player's set of symbols is complete 1144, then the multiplayer hedged offer skill wagering system ranks the player's sets of symbols to determine 1148 a winning player and displays, 1150 and 1028, to the winning player all of the revealed potential award values that have been revealed during gameplay. At this time, the player knows what potential award values were in the set of award values and what award values of the set of award values have been revealed, accordingly the player knows that the award value that the player selected from the set of award values at the beginning of gameplay is one of the award values that has not yet been revealed.

Referring now to FIGS. 9H, 9I, and 10B, the multiplayer hedged offer skill wagering system generates a hedged offer award to present, 1152 and 1030, to the player as a hedged offer award value that the player either chooses to accept or not. If the player accepts 1156 the hedged offer award, the player will be awarded 1160 that hedged offer award value instead of the potential award value that the player selected from among the set of potential award values. If the player does not accept 1154 the hedged offer award, the player is awarded, 1158 and 1032, the potential award value that the player selected at the beginning of game play.

In some embodiments, the value of the hedged offer award is the winning player's expectancy or expected value based on the potential award values of the set of award values that are still hidden at the end of game play.

In some embodiments, the value of the hedged offer award is less than the winning player's expectancy or expected value based on the potential award values of the set of award values that are still hidden at the end of game play. In some such embodiments, the hedged offer award is between 1% to 10% less than the winning player's expectancy or expected value based on the potential award values of the set of award values that are still hidden at the end of game play.

In some embodiments, the value of the hedged offer award is more than the player's expectancy or expected value. In some such embodiments, the hedged offer award is between 1% to 10% more than the player's expectancy or expected value.

In some embodiments, the set of symbols represent a virtual deck of playing cards.

In many embodiments, a virtual deck of playing cards utilized by a multiplayer hedged offer skill wagering system has 4 suits, namely hearts, diamonds, clubs and spades, with each suit having 13 valued cards, namely ace, 2, 3, 4, 5, 6, 7, 8 9 10, jack, queen, and king.

In various embodiments, two symbols are allocated to two or more players as an initial subset of symbols to each player's set of symbols.

In some embodiments, a size of a player's set of symbols is five.

In many embodiments, players' sets of symbols are ranked accorded to a set of poker rules.

In many embodiments, a single player hedged offer skill wagering system presents an interactive application in the form of an interactive game a single player. During the interactive game, the player is presented with one or more hedged offer award values. The player can either select to receive the one or more hedged offer award values or select to continue playing the interactive game until an award value is determined based on the player's performance in the interactive game.

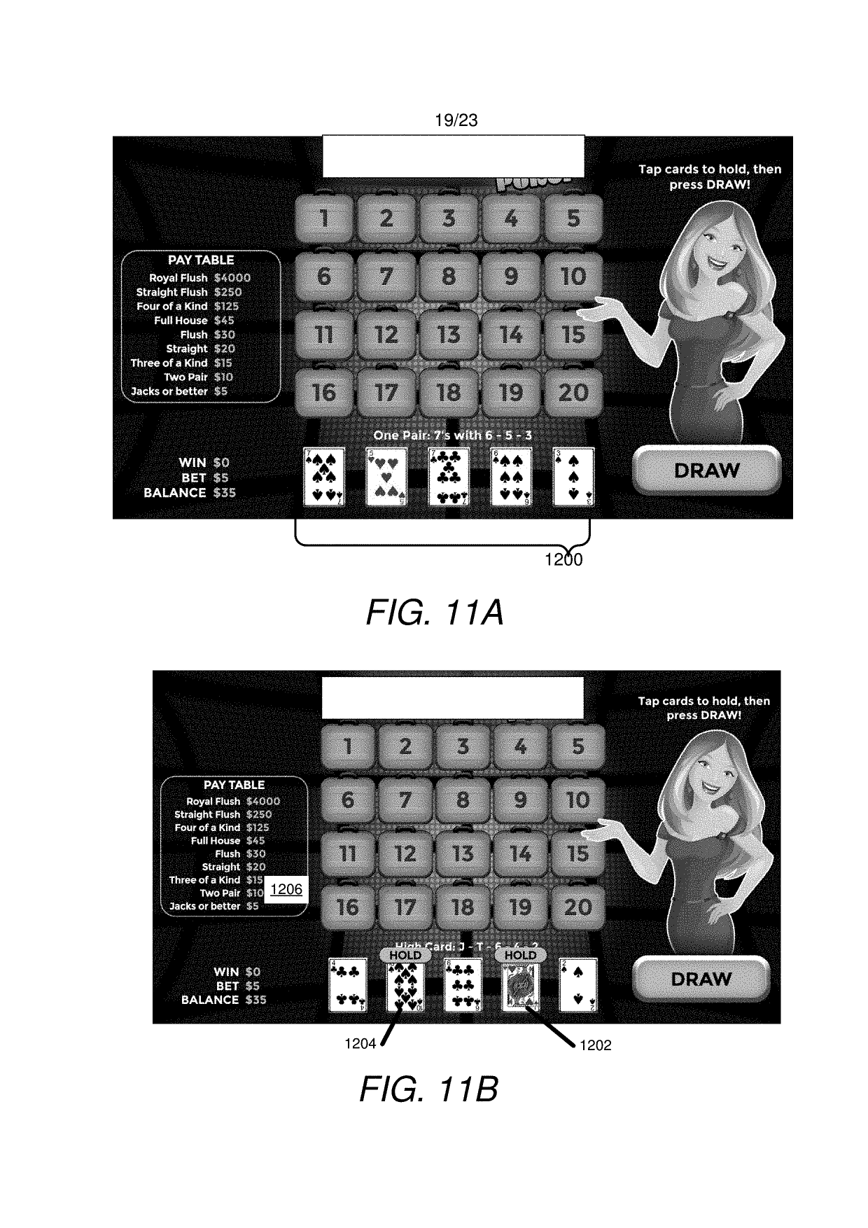

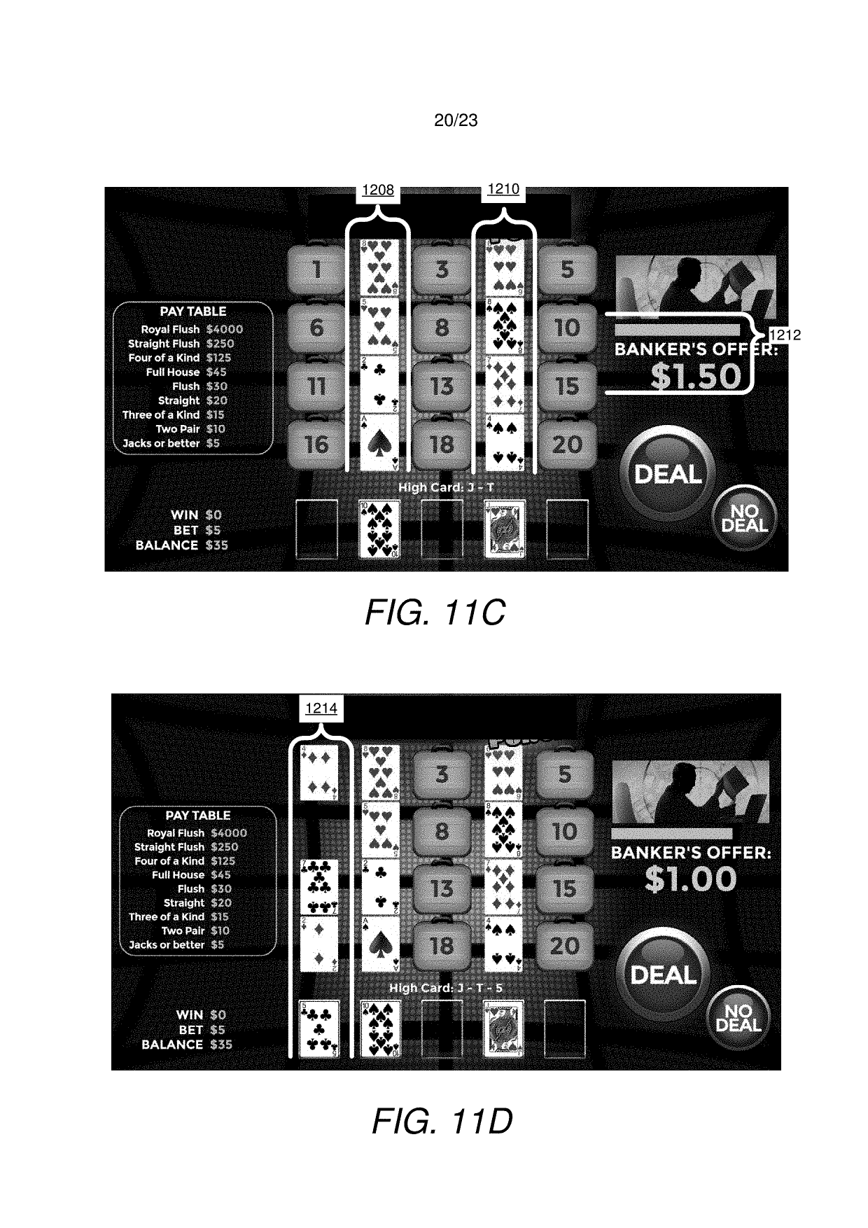

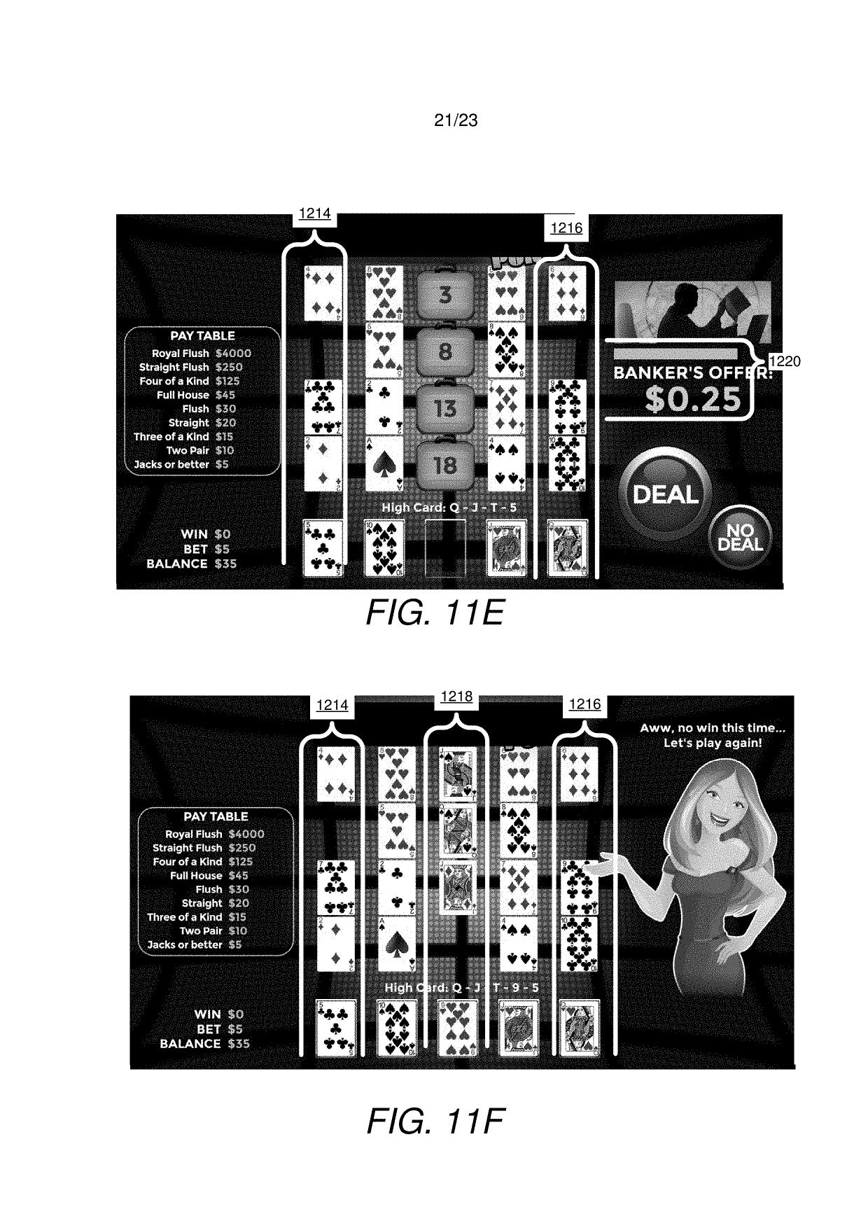

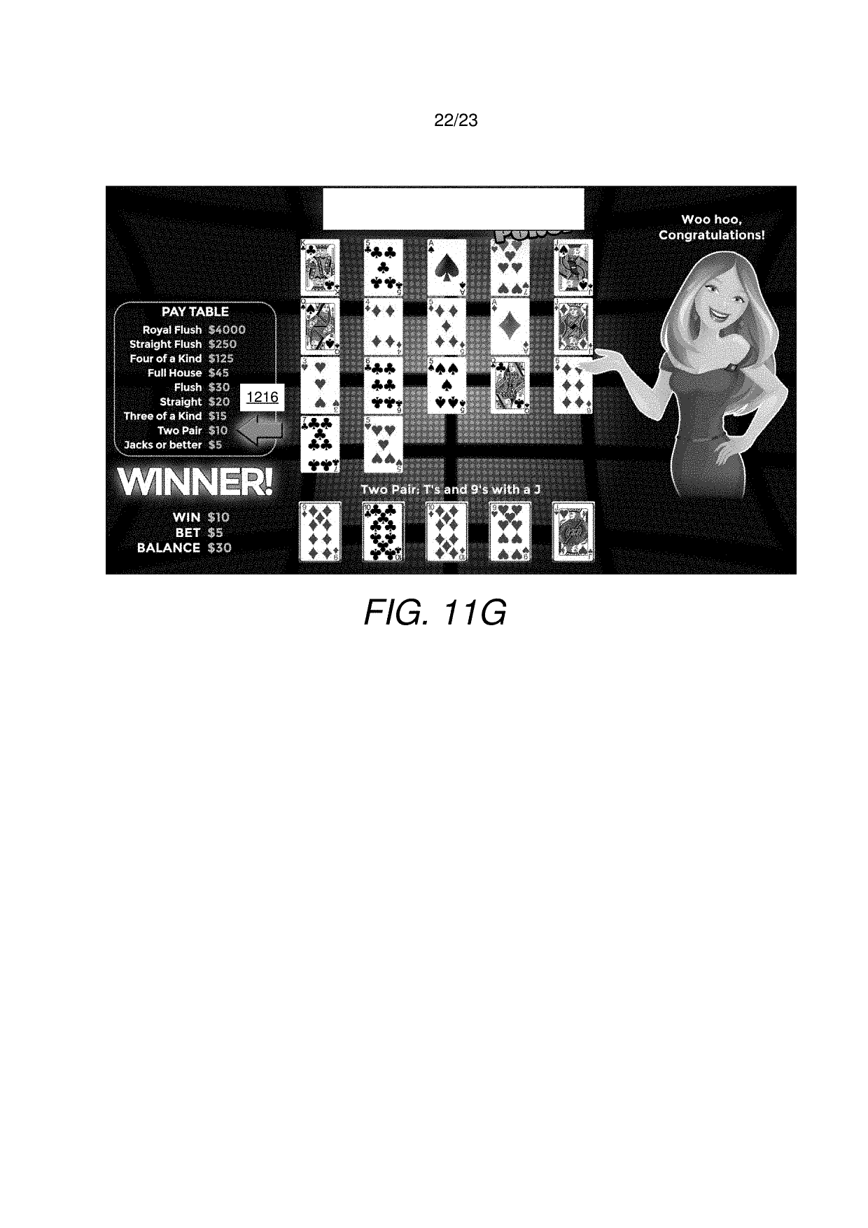

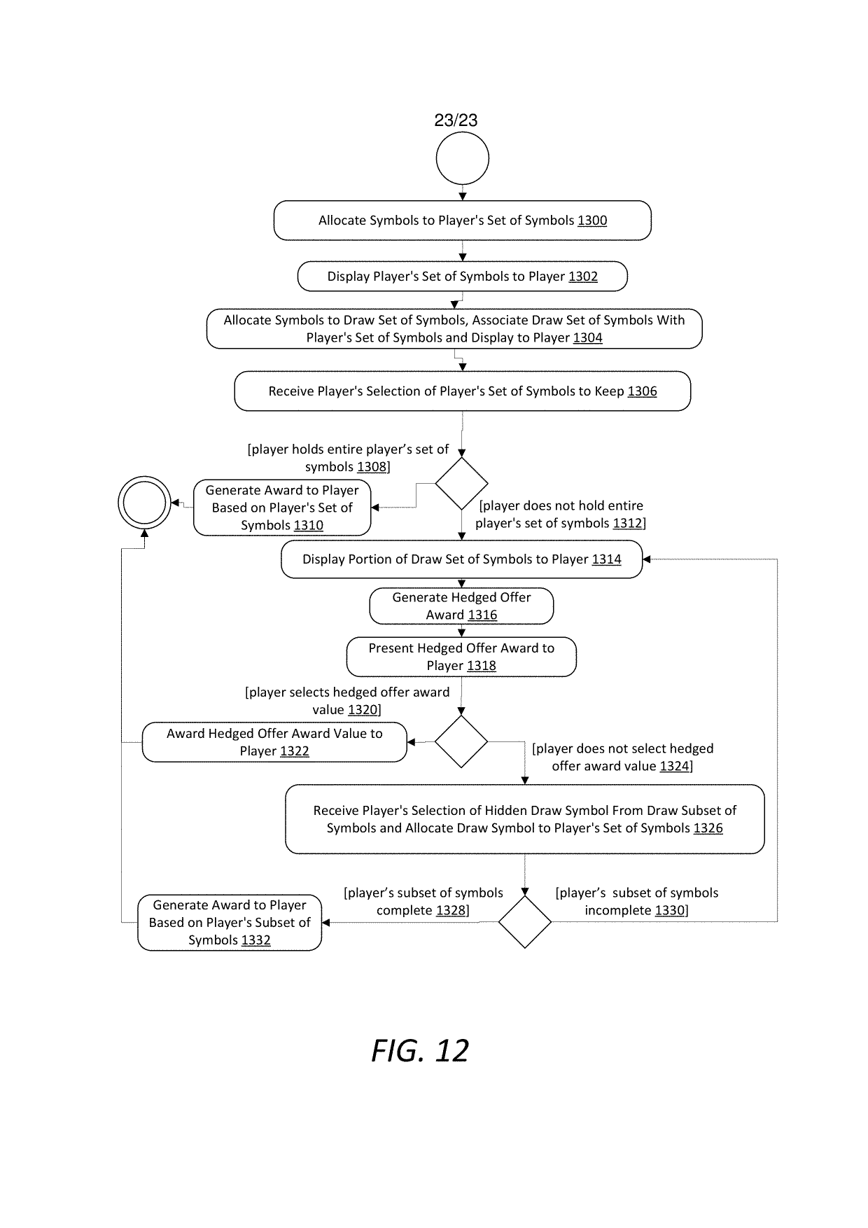

FIGS. 11A to 11G illustrate portions of a user interface of a single player hedged offer skill wagering system in accordance with various embodiments of the invention. FIG. 12 is an activity diagram of a single player hedged offer skill wagering system in accordance with various embodiments of the invention.

Referring now to FIGS. 11A and 12, the single player hedged offer skill wagering system generates a randomized set of symbols as a random component as described herein. The single player hedged offer skill wagering system randomly allocates 1300 one or more symbols of the randomized set of symbols to a player as the player's set of symbols 1200. One or more symbols of the player's set of symbols are displayed, 1302 and 1200, to the player. The single player hedged offer skill wagering system allocates 1304 a plurality of symbols of the set of symbols to a draw set of symbols. The draw set of symbols are hidden from the player and are represented with icons 1202 in the user interface. The single player hedged offer skill wagering system associates two or more of the symbols in the draw set of symbols with a respective one of the symbols in the player's set of symbols such that each symbol of the player's set of symbols is exclusively associated with two or more symbols of the draw set of symbols.

Referring now to FIG. 11B and FIG. 12, the single player hedged offer skill wagering system receives from the player a selection of none or more hold symbols, such as held symbols 1202 and 1204, from the player's set of symbols. If the player chooses to hold 1308 all of the symbols in the player's set of symbols, then the player is awarded 1310 an award value in accordance with a paytable, such as paytable 1206, that associates a ranking of the player's set of symbols to a one or more award values to be awarded to the player.

Referring now to FIGS. 11C, 11D, and 12, if the player does not hold all symbols in the player's set of symbols 1312, for each held hold symbol, the single player hedged offer skill wagering system reveals, 1314, 1208, and 1210, the draw symbols that are associated with any of the held hold symbols. The single player hedged offer skill wagering system generates 1316 a hedged offer award value and presents, 1318 and 1212, the hedged offer award value to the player. If the player selects to receive the hedged offer award value, the hedged offer skill wagering system receives 1320 the player's selection of the hedged offer award value and awards 1322 the hedged offer award value to the player. If the player does not select 1324 to receive the hedged offer award value, the hedged offer skill wagering system receives 1326 the player's selection of a draw symbol from the draw set of symbols that are associated with a discarded symbol of the player's set of symbols. The selected draw symbol is added to the player's set of symbols 1214 and the unselected draw symbols associated with the discarded symbol are displayed to the player.

Referring now to FIG. 11G and FIG. 12, if the player's set of symbols is complete 1328 after adding the selected draw symbol, the player's set of symbols is ranked and an award value is generated 1332 and awarded 1216 to the player on the basis of the ranked player's set of symbols and the ranked set of symbols paytable.

Referring now to FIGS. 11D, 11E and 12, if the player's set of symbols is not complete 1330, the single player hedged offer skill wagering system displays 1314 all other draw symbols associated with the discarded symbol, 1214, 1216, and 1218, to the player and proceeds to continue game play until either the player selects a hedged offer award value 1220 or the player's set of symbols is complete.

In some embodiments, the value of the hedged offer award is the player's expectancy or expected value based on the remaining number of possible player's set of symbols that can be generated given the existing player's set of symbols and the set of remaining draw symbols that are not shown to the player as determined from a paytable mapping the possible player's set of symbols to possible award values.

In some embodiments, the value of the hedged offer award is less than the player's expectancy or expected value. In some such embodiments, the hedged offer award is between 1% to 10% less than the player's expectancy or expected value.

In some embodiments, the value of the hedged offer award is more than the player's expectancy or expected value. In some such embodiments, the hedged offer award is between 1% to 10% more than the player's expectancy or expected value.

In some embodiments, the set of symbols represent a virtual deck of playing cards.

In many embodiments, a virtual deck of playing cards utilized by a multiplayer hedged offer skill wagering system has 4 suits, namely hearts, diamonds, clubs and spades, with each suit having 13 valued cards, namely ace, 2, 3, 4, 5, 6, 7, 8 9 10, jack, queen, and king.

In various embodiments, five symbols are allocated to the player as an initial subset of symbols to the player's set of symbols.

In many embodiments, player's set of symbols is ranked accorded to a set of poker rules.

In some embodiments, the system increases a subsequent award value if the player has been awarded a previous award value. In some such embodiments, the magnitude of the increase is randomly determined. In some such embodiments, the increase is a multiplier multiplied by the current award value. In some embodiments, the multiplier is an integer multiplier. In an example embodiment, the player's set of symbols is a virtual poker hand and the virtual poker hand is ranked in accordance with a set of poker rules. If the player has a virtual poker hand of two jacks or better, the system will increase a subsequent award value by a multiplier of between 2 times and 5 times that will be applied to the subsequent award value for a subsequent virtual poker hand.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. A multiplayer hedged offer skill wagering system, comprising:
at least one processor; and
a memory connected to the at least one processor, wherein the memory stores processor executable instructions that when executed by the processor cause the processor to:
present an interactive application in the form of an interactive game to two or more players;
receive a selection from each of the two or more player's of respective hidden possible award values from a set of hidden possible award values;
determine a winning player based on the relative performance of the two or more players in the interactive game;
present to the winning player a hedged offer award value;
receive a selection from the winning player a selection of the hedged offer award value or a selection of a the player's respective hidden possible award value; and
award to winning player the selected award value.

2. The multiplayer hedged offer skill wagering system of claim 1, further comprising:
an enclosure constructed to mount:
a user input device operatively connected to the processor;
a user output device operatively connected to the processor;
a credit input device operatively connected to the processor; and
a credit output device operatively connected to the processor.

3. A single player hedged offer skill wagering system, comprising:
at least one processor; and
a memory connected to the at least one processor, wherein the memory stores processor executable instructions that when executed by the processor cause the processor to:
present an interactive application in the form of an interactive game a player;
during play of the interactive game by the player, present to the player a hedged offer award value;
receive a selection from the winning player a selection of the hedged offer award value or a selection by the player to continue playing the interactive game; and
award to the player the selected hedged offer award value when the player selects to receive the hedged offer award value.

4. The single player hedged offer skill wagering system of claim 3, further comprising:
an enclosure constructed to mount:
a user input device operatively connected to the processor;
a user output device operatively connected to the processor;
a credit input device operatively connected to the processor; and
a credit output device operatively connected to the processor.
